(19) United States
(12) Patent Application Publication
(10) Pub. No.: US 2016/0240831 A1
(43) Pub. Date: Aug. 18, 2016

(54) DENDRITE-RESISTANT BATTERY

(71) Applicant: Apple Inc., Cupertino, CA (US)

(72) Inventors: Qingcheng Zeng, San Jose, CA (US); Richard M. Mank, Los Altos, CA (US); Jie Guan, Torrance, CA (US); Shouwei Hao, Gilroy, CA (US); Bookeun Oh, Fremont, CA (US)

(73) Assignee: Apple Inc., Cupertino, CA (US)

(21) Appl. No.: 15/043,109

(22) Filed: Feb. 12, 2016

Related U.S. Application Data
(60) Provisional application No. 62/115,551, filed on Feb. 12, 2015.

(51) Int. Cl. H01M 2/16; H01M 10/04; H01M 10/0525; H01M 4/38

(52) U.S. Cl. CPC H01M 2/1686; H01M 4/382; H01M 10/0436; H01M 10/0525; H01M 2220/30

(57) ABSTRACT

An apparatus includes a first electrode, a second electrode, and a porous layer positioned between the first electrode and the second electrode. The porous layer resists dendrite growth from the first electrode through the porous layer to the second electrode. The porous layer includes a plurality of pores sized to permit ionic transport through the porous layer and to resist dendrite growth through the porous layer.

### PRIORITY

This application claims priority from U.S. Provisional Application No. 62/115,551, entitled “Lithium Dendrite-Resistant Battery” and filed Feb. 12, 2015, the contents of which is incorporated by reference in its entirety herein.

### BACKGROUND

1. Technical Field

The disclosed embodiments relate to batteries configured to provide electrical power support to at least some portion of one or more portable electronic devices. More specifically, the disclosed embodiments relate to at least partially resisting dendrite growth between electrodes of a battery.

2. Description of the Related Art

Rechargeable batteries are presently used to provide power to a wide variety of portable electronic devices, including laptop computers, cell phones, PDAs, digital music players and cordless power tools. As these electronic devices become increasingly smaller and more powerful, the batteries that are used to power these devices need to store more energy in a smaller volume.

A commonly used type of rechargeable battery is a lithium battery, which can include a lithium-ion battery or a lithium-polymer battery. Some lithium batteries may be thin-film batteries with a solid electrolyte. Lithium-ion and lithium-polymer batteries typically contain one or more cells that include a cathode current collector; a cathode comprised of an active material, a separator, an anode current collector; and an anode comprised of an active material. The cathode can comprise a cathode coating, and the anode can comprise an anode coating.

Lithium batteries conventionally include an anode that is comprised of a graphite material and a cathode that is comprised of a lithium salt material. One technique for increasing the energy capacity (mAh) of a lithium-ion or a lithium-polymer battery involves comprising the anode of a lithium metal material. A lithium battery that includes a lithium metal anode can be configured to have substantially increased energy capacity, relative to a lithium battery of similar size that includes a graphite anode.

However, charging and discharging such a lithium battery, in some cases, results in the formation of lithium metal structures on the surfaces of the anode. Such structures, referred to herein as lithium dendrites, can “grow” outward from the anode due to repeated charging and discharging cycles of the lithium battery. Some of the lithium dendrites can grow between the anode and the cathode, including growing through various portions of the battery, including one or more battery separators, electrolyte layers, etc. Over time, some lithium dendrites can “grow” in a direction that results in the lithium dendrites approaching the cathode. When a lithium dendrite reaches the cathode, an electrical short circuit (also “short” herein) can be established between the electrodes via the lithium metal comprising the lithium dendrite. Such an electrical short can result in failure of the battery and can further impose a safety risk due to overheating of the battery due to the short circuit, which can further lead to a fire.

### SUMMARY OF EMBODIMENTS

In the descriptions presented below, reference may be made to a lithium battery that comprises one or more lithium cells. However, the apparatuses and methods described may be applicable to other cells and batteries that are not lithium-based. For example, an electrochemical cell of a battery may have an anode on which dendrites can grow, and the apparatuses and methods presented herein may be applied to resist, impede, suppress, and/or prevent one or more dendrites from causing a short circuit between the electrodes of the cell.

Some embodiments include an apparatus that further includes a battery, such as a lithium battery that is configured to at least partially suppress or resist lithium dendrite growth between electrodes of the battery. The lithium battery, which can include one or more of a lithium ion battery, a lithium polymer battery, a thin film lithium ion battery, etc., typically includes an electrochemically-neutral porous layer configured to permit lithium ion transport across the porous layer and resist or suppress lithium dendrite growth across the porous layer. The electrochemically-neutral porous layer can include a porous anodic aluminum oxide (AAO) layer, which includes pores that may include apertures that extend from a particular surface of the porous layer to an opposite surface of the porous layer, and that are configured to permit lithium ion migration across the AAO layer and to resist lithium dendrite growth across the AAO layer. The electrodes can include a lithium metal anode. The lithium battery can include a battery separator coupled to at least one side of the electrochemically-neutral porous layer, and the battery separator can inhibit lithium ion transport between the electrodes of the lithium battery, based at least in part upon a temperature of the battery separator. The lithium battery can include a liquid electrolyte portion located on at least one side of the electrochemically-neutral porous layer. The lithium battery can include a solid electrolyte portion located on at least one side of the electrochemically-neutral porous layer. The solid electrolyte portion can include a solid electrolyte layer that is applied to at least one side of the electrochemically-neutral porous layer such that the electrochemically-neutral porous layer at least partially structurally supports the solid electrolyte layer, and the electrochemically-neutral porous layer can be applied to at least one side of at least one of the electrodes.

Some embodiments include a method that includes at least partially fabricating a battery including one or more cells and that can resist dendrite growth between electrodes of a cell of the battery. For example, the battery may be a lithium battery that includes one or more lithium cells, each lithium cell having electrodes including an anode that includes lithium metal. The method includes providing an electrochemically-neutral porous layer between the electrodes. For a lithium battery that includes at least one lithium cell, the electrochemically-neutral porous layer is configured to permit lithium ion transport across the porous layer and to resist lithium dendrite growth from the lithium anode across the porous layer. The electrochemically-neutral porous layer can include a porous anodic aluminum oxide (AAO) layer that comprises a plurality of pores that are configured to permit lithium ion transport across the AAO layer and suppress lithium dendrite growth across the AAO layer.

Providing the electrochemically-neutral porous layer between the electrodes can include laminating at least the electrochemically-neutral porous layer to at least at least one battery separator, wherein the at least one battery separator is configured to inhibit lithium ion transport between the electrodes of the lithium battery, based at least in part upon a temperature of the at least one battery separator. Providing the electrochemically-neutral porous layer between the electrodes can include applying a solid electrolyte layer to at least one side of the electrochemically-neutral porous layer, such that the electrochemically-neutral porous layer at least partially structurally supports the solid electrolyte layer. Subsequent to applying the solid electrolyte layer, the electrochemically-neutral porous layer may be applied to at least one of the electrodes, on at least one other side of the electrochemically-neutral porous layer, such that the solid electrolyte layer is configured to conduct lithium ions between the electrodes via at least one portion of the electrochemically-neutral porous layer. Applying the solid electrolyte to at least one side of the electrochemically-neutral porous layer can include performing at least one of laminating the solid electrolyte layer to at least one side of the electrochemically-neutral porous layer, depositing the solid electrolyte layer on at least one side of the electrochemically-neutral porous layer, or coating the solid electrolyte layer on at least one side of the electrochemically-neutral porous layer. Providing the electrochemically-neutral porous layer between the electrodes can include laminating the electrochemically-neutral porous layer to at least a portion of the lithium battery. In embodiments, the electrochemically-neutral porous layer can include pores having a maximum pore diameter of 100 nanometers.

Some embodiments include a portable electronic device that includes at least one functional component that is configured to consume electrical power, and a lithium battery that is configured to provide electrical power support to the at least one functional component. The lithium battery is configured to at least partially suppress lithium dendrite growth between electrodes of the lithium battery, and the lithium battery includes an electrochemically-neutral porous layer that permits lithium ion transport across the porous layer and suppresses lithium metal transport across the porous layer. The electrochemically-neutral porous layer can include a porous anodic aluminum oxide (AAO) layer that comprises a plurality of pores that permit lithium ion transport across the AAO layer and suppress lithium dendrite growth across the AAO layer. The lithium battery can include a solid electrolyte layer that is applied to at least one side of the electrochemically-neutral porous layer, such that the electrochemically-neutral porous layer at least partially structurally supports the solid electrolyte layer. The lithium battery can include a battery separator coupled to at least one side of the electrochemically-neutral porous layer and the battery separator can inhibit lithium ion transport between the electrodes of the lithium battery, based at least in part upon a temperature of the at least one battery separator.

### BRIEF DESCRIPTION OF THE DRAWINGS

FIGS. 1A-1B illustrate lithium batteries that include dendrites growing between electrodes in the respective batteries, according to some embodiments.

FIG. 2 illustrates a perspective view of an electrochemically-neutral porous layer that is configured to permit lithium ion transport and suppress lithium dendrite growth, according to some embodiments.

FIG. 3 illustrates an exploded view of a lithium battery that includes an electrochemically-neutral porous layer, which suppresses lithium dendrite growth between the electrodes, according to some embodiments.

FIGS. 4A-4D illustrate perspective views of lithium batteries, which include an electrochemically-neutral porous layer and at least one battery separator, according to some embodiments.

FIG. 5 illustrates an exploded view of a lithium battery, which includes multiple layers arranged in a cylindrical coil configuration, according to some embodiments.

FIG. 6 illustrates a cross-sectional view of a lithium battery, which includes an electrochemically-neutral porous layer, according to some embodiments.

FIG. 7 illustrates a cross-sectional view of a lithium battery, which includes an electrochemically-neutral porous layer, according to some embodiments.

FIG. 8 illustrates an exploded view of a lithium battery that includes an electrochemically-neutral porous layer and one or more extended structures coupled to one or more sides of the porous layer, according to some embodiments.

FIG. 9 illustrates a process for fabricating a lithium battery, according to some embodiments.

FIG. 10 is a block diagram illustrating an electronic device in accordance with some embodiments.

FIG. 11 illustrates an exemplary electronic device having a touch screen in accordance with some embodiments.

FIG. 12 illustrates an exemplary computer system in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., a field programmable gate array (FPGA) or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not necessarily imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION OF EMBODIMENTS

In the descriptions presented below, reference may be made to a lithium battery that comprises one or more lithium cells. However, the apparatuses and methods described may be applicable to other cells and batteries that are not lithium-based. For example, an electrochemical cell of a battery may have an anode on which dendrites can grow, and the apparatuses and methods presented herein may be applied to resist, impede, suppress, and/or prevent one or more dendrites from causing a short circuit between the electrodes of the cell.

Various embodiments of an apparatus that includes a lithium battery that is configured to resist lithium dendrite growth between electrodes of the lithium battery and methods for at least partially fabricating the apparatus are disclosed.

### Lithium Batteries

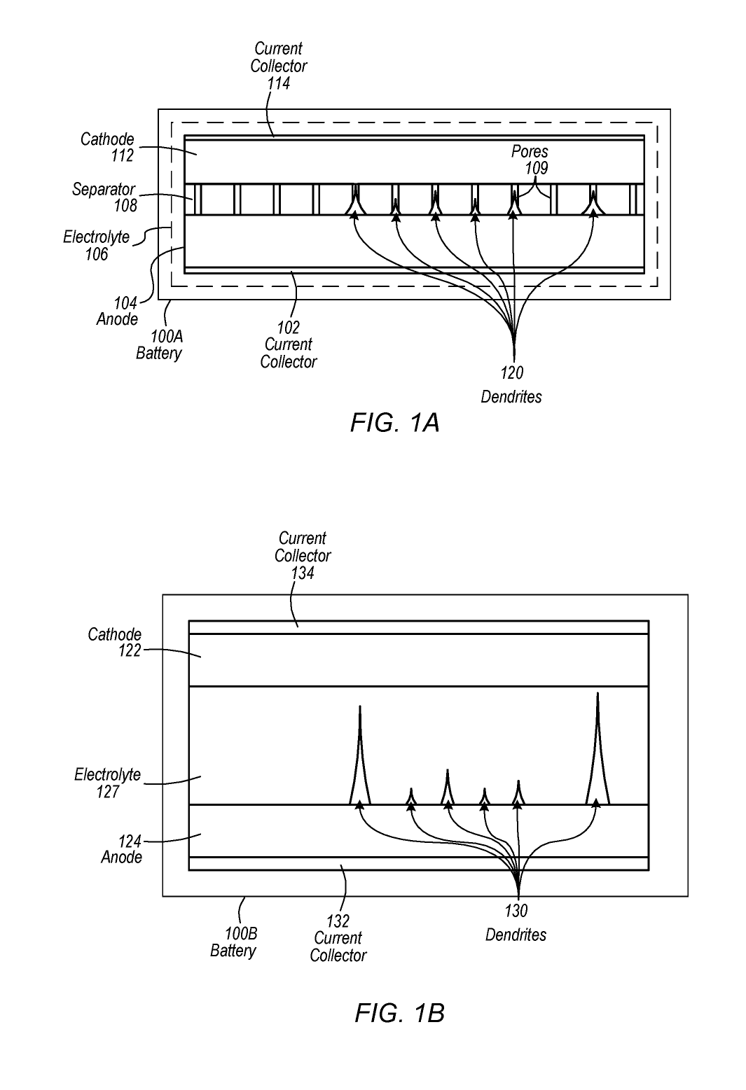

FIGS. 1A-1B illustrate lithium batteries that include dendrites growing between electrodes in the respective batteries, according to some embodiments. FIG. 1A illustrates a battery 100A, which includes a liquid electrolyte 106. FIG. 1B illustrates a battery 100B, which includes a solid electrolyte 127.

Each battery 100A, 100B, shown in FIGS. 1A-1B, includes a respective anode 104, 124, a respective cathode 112, 122, and respective current collectors (102, 114), (132, 134) coupled to distal surfaces of the respective electrodes (104, 112), (124, 122). Battery 100A further includes a battery separator 108, which separates the two electrodes 104, 112, and an electrolyte 106 in which components 102, 104, 108, 112, 114 are immersed. In some embodiments, the liquid electrolyte 106 is included in a limited portion of the battery 100A. For example, the electrolyte 106 can be included in the separator 108. Battery 100B includes a solid electrolyte layer 127, which is located between the electrodes 124, 122.

A lithium battery can include at least one cathode, anode, and electrolyte, which are comprised of various materials. In some embodiments, a lithium battery includes a cathode, which is comprised of one or more various metal oxides. The lithium battery can include electrolyte in one or more various phases. For example, a lithium battery can include a liquid electrolyte, which can include one or more various lithium salts in an organic solvent. In some embodiments, a lithium battery includes an electrolyte layer that includes a molten salt layer. In another example, a lithium battery can include one or more solid electrolyte layers, which can include lithium phosphorous oxynitride (“LiPON”) that can be mixed with one or more various binder substances, which can include one or more of polyvinylidene fluoride (PVDF), carboxymethyl cellulose (CMC), one or more Acrylic substances, etc. A solid electrolyte can form a layer in a battery between the electrodes of the battery. In some embodiments, a lithium battery includes at least one liquid electrolyte and at least one solid electrolyte. For example, a lithium battery can include a solid electrolyte layer located between two electrodes, where a liquid electrolyte is included within a porous structure of at least one of the electrodes. In some embodiments, one or more of the electrodes in a lithium battery includes a liquid electrode.

In some embodiments, battery 100A includes a separator 108 that comprises an at least partially permeable structure that permits the transport of at least some charge carriers, including lithium ions, between the electrodes 104, 112. Such transport can be referred to herein as ionic transport. In some embodiments, the separator 108 includes one or more pores 109 via that one or more charge carriers can pass. In some embodiments, the separator 108 comprises a polymer separator. In some embodiments, the separator 108 is configured to inhibit the electronic transport between the electrodes 104, 112, which can include inhibiting charge carrier transport across the separator 108, based at least in part upon a temperature of the separator 108. Such a separator can be referred to as a “shutdown separator”, because, by inhibiting charge carrier transport based on temperature, the separator is configured to shut down the battery 100A in response to the battery temperature exceeding a certain temperature. As a result, in addition to keeping the electrodes separated, the separator 108 mitigates safety hazards associated with operation of the battery 100A. Such a configuration can be associated with the physical structure and composition of the separator. For example, a shutdown separator can be at least partially comprised of one or more polymer materials, including polyethylene, which can melt in response to the local temperature exceeding a threshold, where the melted material coats one or more portions of the separator with a nonconductive layer that inhibits charge carrier transport across the separator, and thus inhibits charge carrier transport between the electrodes.

In some embodiments, an electrolyte may be used to achieve separation between the electrodes. For example, battery 100B, which includes electrolyte layer 127 that can include a layer including a solid electrolyte material, does not include a separator between the electrodes 124 and 122. In some embodiments, battery 100B includes a liquid electrolyte, which is included within one or more portions of the battery, such that the liquid electrolyte facilitates ionic transport between the solid electrolyte layer 127 and one or more other portions of the battery. For example, where electrolyte layer 127 is a solid electrolyte, cathode 122 can comprise a porous structure in which a liquid electrolyte is included, where the liquid electrolyte can facilitate ionic transport between the solid electrolyte layer 127 and the cathode 122.

In some embodiments, the anode (104, 124) of one or more of batteries 100A-100B is comprised of one or more materials that include lithium metal. For example, the anode 104 or 124 can be comprised entirely of lithium metal. As shown in the illustrated embodiments FIG. 1A-100B, as the battery 100A or 100B is repeatedly charged and discharged over time, deposits 120, 130 of lithium metal can form on a surface of the anode 104, 124, and “grow” outward from the anode into the interior structure of the battery 100A- or 100B. These deposits, referred to herein as “dendrites”, can grow through various portions of the battery. For example, as shown in FIG. 1A, dendrites 120 extend outwards from a surface of anode 104 and at least partially through the separator 108 that is located between the electrodes 104, 112 in battery 100A. In another example, as shown in FIG. 1B, dendrites 130 extend outwards from a surface of anode 124 and at least partially through the electrolyte layer 127, which is located between the electrodes 124 and 122 in battery 100B. Because the dendrites can be at least partially comprised of lithium metal, a dendrite that grows across an entirety of the separation between the electrodes to establish at least electrical contact with the cathode 122 can establish an electrical short circuit (also “short” herein) between the cathode and anode via the dendrite. Such an electrical short can cause failure of the battery and can also produce a safety hazard, including overheating of the battery based on the short, which can lead to a fire.

In some embodiments, a battery separator in a lithium battery, including a shutdown separator configured to shut down the battery in response to a threshold local temperature, is at least partially permeable by lithium metal such that a lithium dendrite that reaches the separator from the anode can grow through the separator and continue growing towards the cathode. Such permeability can be associated with the pore structure of the separator, where the pores of the separator are sufficiently large so as to permit lithium dendrite growth across the separator. In the illustrated embodiment shown in FIG. 1A, the dendrites 120 are shown to be growing through the separator 108 via pores 109 in the separator.

If the dendrites 120, 130, shown in FIGS. 1A and 1B, continue to grow as a result of repeated charging and discharging of the respective battery 100A, 100B, the dendrites can eventually reach the respective cathode 112, 122 of the respective battery and establish an electrical short between the respective pair of electrodes (112 and 104) or (122 and 124). In addition, growth of dendrites 120 through the separator 108 of battery 100A can impart conductivity to the separator 108, as dendrites 120 comprise electronically conductive lithium material. In embodiments, where the separator 108 is configured to shut down the battery 100A by forming a nonconductive barrier (e.g., due to heating effects that may be associated with overcharging), dendrite growth through the separator 108 can render the separator conductive and therefore an ineffective shutdown mechanism. As a result, the dendrites 120 can present an additional safety hazard, even if the dendrites do not extend sufficiently between the electrodes to cause a short, by at least partially suppressing the ability of the separator 108 to shut down the battery 100A in the event of the battery temperature exceeding a threshold temperature.

### Electrochemically-Neutral Porous Layer

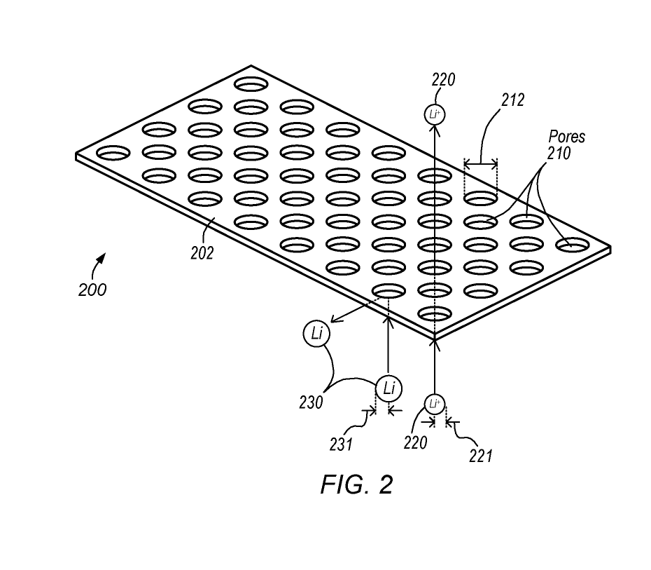

FIG. 2 illustrates a perspective view of an electrochemically-neutral porous layer that is configured to permit lithium ion transport and resist lithium dendrite growth, according to some embodiments. The electrochemically-neutral porous layer, also referred to herein interchangeably as a “porous layer,” can be included in any of the porous layers included in any of the embodiments included herein.

In some embodiments, an electrochemically-neutral porous layer is configured to permit at least some charge carriers, including lithium ions, to pass through the layer and is further configured to at least partially suppress or inhibit certain materials, including lithium dendrites, from growing through the layer. As a result, the porous layer is configured to at least partially suppress or inhibit lithium dendrites growing on one side of the porous layer from growing through the porous layer to another side of the porous layer.

Lithium atoms and lithium ions can have different sizes, i.e., a lithium ion is smaller in radius than the radius of the atom. The size of an atom can be expressed as the “atomic radius” of the atom, and the size of an ion can be expressed as the “ionic radius” of the ion. While some ions, including anions, have an ionic radius that is larger than the atomic radius of the corresponding atom, other ions, including the lithium ion, can have an ionic radius that is smaller than the atomic radius of the corresponding atom. For example, a lithium atom 230 is understood to have an atomic radius 231 of approximately 145-182 picometers. In addition, the radius of lithium in a metallic lattice is further understood to be approximately 152 picometers. In contrast, the ionic radius 221 of the lithium ion 220 (having a +1 charge) is understood to be approximately 68-78 picometers.

In some embodiments, a porous layer that permits lithium ion transport and resists, inhibits or suppresses lithium dendrite growth includes a structure that further includes a set of pores through which charge carriers, including lithium ions, can pass. The pores have diameters that are sufficiently large to permit lithium ions to pass through the pores and sufficiently small to suppress lithium dendrites from growing through the pores. In some embodiments, the pores have diameters that are sufficiently large to permit lithium ions to pass through the pores, referred to herein as lithium ion transport, and sufficiently small to suppress lithium metal lattices, lithium dendrites, or some combination thereof, etc., from growing through the pore.

Due at least in part to aggregation of lithium atoms to form dendrites, if pore diameter is sized between approximately 10 and 200 nanometers, the lithium ion 220 can pass through pores 210 but a dendrite, e.g., metallic lattice that may include lithium, may be too large to pass through one or more of the pores 210; that is, the dendrite may be resisted, impeded, or suppressed from passing through one or more of the pores 210.

In some embodiments, an electrochemically-neutral state of the porous layer mitigates reaction hazards associated with the presence of the porous layer in a lithium battery. The electrochemically-neutral porous layer is less prone to chemically interacting with chemical elements of the lithium battery than, e.g., an electrochemically active layer, which could otherwise pose a safety hazard from unexpected and harmful chemical reactions between the layer and one or more chemical substances in the battery.

In the illustrated embodiment of FIG. 2, porous layer 200 includes a structure 202 that forms an arrangement of pores 210 that extend through opposite surfaces of the layer 200. The arrangement of pores 210 can include pores 210 having a substantially uniform diameter 212 between approximately 20 nanometers and approximately 200 nanometers, although pores with diameters as large as 500 nanometers may impede, resist, or otherwise at least partially suppress dendrites from passing through the porous layer 200. In some embodiments, the porous layer 200 structure 202 is comprised of one or more various materials that result in an electrochemically-neutral dielectric structure 202 and where the porous layer permits lithium ion flow through the pores and resists/inhibits passage of lithium dendritic structures through the pores. In some embodiments, structure 202 comprises anodic aluminum oxide (AAO), and the porous layer 200 can be referred to as a porous AAO layer. AAO is a suitable material from which to form the structure 202 due to its dielectric nature and because it can be formed into a porous layer with pores sized to permit flow of lithium ions through the pores and to resist/inhibit flow of macroscopic lithium structures (e.g., dendrites) through the pores. Other materials may be suitable to form a thin layer (e.g., thickness approximately 50-100 microns) such as the structure 202, and are dielectric and can be formed into a porous layer. Some or all of the pores of the structure 202 formed from another material may have diameters sized to permit lithium ions to pass through from a first surface of the structure to a second surface of the structure, and impede lithium dendrites from passing through from the first surface of the structure to the second surface of the structure.

As shown, some or all of the pores 210 have a sufficiently large diameter 212 to permit lithium ions 220 that have a radius 221 to pass through the pores of the porous layer 200. Conversely, some or all of the pores 210 have a sufficiently small diameter 212 to resist, impede, inhibit, or suppress clusters of atoms (e.g., clusters of lithium atoms 230, each lithium atom 230 having a radius 231) such as dendrites or dendrite clusters, from passing through the pores of the porous layer 200. In some embodiments, the pores 210 are sufficiently small to resist, impede, inhibit, or suppress metal lattices comprising lithium, including lithium dendrites, from growing through the layer via the pores 210. As a result, lithium dendrite growth through the pores in the layer 200 is resisted, impeded, inhibited, or at least partially suppressed.

In some embodiments, one or more electrolyte substances are included in the porous layer 200, where the one or more electrolyte substances facilitate ionic transport between opposite surfaces of the porous layer 200 via one or more of the pores 210, the structure 202 of the layer 200, etc. For example, a liquid electrolyte substance can be included within the porous structure of the porous layer 200, where the liquid electrolyte facilitates ionic transport, including transport of lithium ions 220, through the porous layer 200.

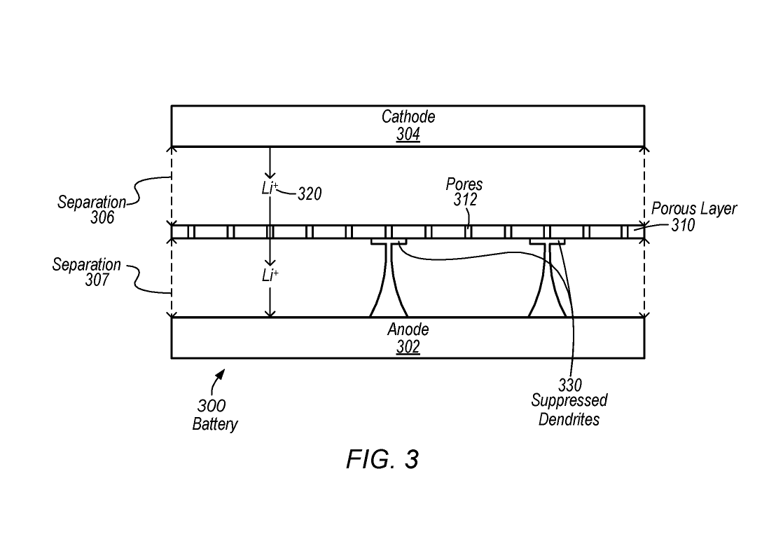

FIG. 3 illustrates an exploded view of a lithium battery that includes an electrochemically-neutral porous layer that suppresses lithium dendrite growth between the electrodes, according to some embodiments. The battery 300 shown in FIG. 3 can include any of the lithium batteries included in any of the embodiments herein, including a battery that includes a liquid electrolyte, a battery that includes a solid electrolyte, a battery that includes at least one liquid electrode, or some combination thereof.

Battery 300 includes an anode 302, a cathode 304, and an electrochemically-neutral porous layer 310 between the two electrolyte regions, where the porous layer 310 includes a set of pores 312 that extend between opposite surfaces of the layer 310 and the opposite surfaces of the layer 310 face into opposite portions of the battery 300. The illustrated view of the battery 300 is an exploded view to better illustrate features of the battery 300, e.g., in FIG. 3, the electrodes (e.g., anode 302 and cathode 304) are separated from the porous layer 310 by separation distances 306 and 307, respectively. In some embodiments, one or both of the separation distances 306, 307 is substantially absent (e.g., of substantially zero length), such that at least one surface of the porous layer 310 contacts a surface of at least one of the electrodes 302, 304. In some embodiments, one or more portions of the battery 300 are located between the porous layer 310 and at least one electrode 302, 304. In one example, battery 300 can include a separator layer (not shown in FIG. 3) between the cathode 304 and the porous layer 310, while porous layer 310 can be in physical contact with a surface of the anode 302, and a liquid electrolyte can be included in the separator layer (also “separator” herein) between the cathode 304 and the porous layer 310. In various embodiments, the separator layer may include any of polypropylene (PP), polyethylene (PE), polyimide (PI), polyethylene terephthalate (PET), or a combination thereof. When a separator is present, the porous layer 310 can be of help in the event of thermal failure of the separator (i.e., when the separator is melting). For example, the porous layer 310 may reduce a melting propagation rate of the separator at high temperatures, and may also prevent the anode from directly contacting the cathode as the separator melts.

In another example, battery 300 can include a solid electrolyte layer (not shown in FIG. 3) between the porous layer 310 and at least one of the electrodes 302, 304, and the porous layer can be in physical contact with at least one other of the electrodes 302, 304. In some embodiments, one of the electrolyte regions is absent, and one of the surfaces of the porous layer 310 is in physical contact with at least a portion of a surface of one of the electrodes 302, 304.

In some embodiments, the porous layer 310 permits lithium ion transport across the porous layer 310 and resists, impedes, or at least partially suppresses lithium dendrite growth across the porous layer 310. As a result, the porous layer 310 facilitates functioning of the battery 300. That is, the porous layer 310 facilitates the exchange of lithium ions 320 between the electrodes 302, 304 and the porous layer 310 resists, impedes, or at least partially suppresses the growth of lithium dendrites 330 in the portion of the battery that includes the electrode 302 from which the dendrites originate and may help to prevent the lithium dendrites 330 from establishing one or more electrical shorts between the electrodes 302 and 304.

As shown, lithium dendrites 330 are growing from a surface of the anode 302. In some embodiments, the anode 302 is comprised of one or more materials that include lithium metal. As the battery 300 is repeatedly charged and discharged over time, the lithium dendrites 330 can “grow” outward from the anode 302 to a proximate surface of the porous layer 310. In some embodiments, separation distance 307 between the anode 302 and the porous layer 310 is minimal, and dendrites protruding from the anode 302 grow directly into contact with the proximate surface of the porous layer 310.

As further shown, the porous layer 310, while permeable to the lithium ions 320, is resistant to the lithium dendrites 330. As a result, dendrites 330 that reach the layer 310 from the anode 302 are impeded or resisted from growing through the layer 310. Thus, the potential for an electrical short caused by a lithium dendrite connecting the electrodes 302, 304 may be mitigated by porous layer 310.

In some embodiments, a lithium battery includes a porous layer that includes pores having a particular selected target pore size, a structure having a particular selected thickness, or both a particular selected pore size and a particular selected thickness. A porous layer can further have a selected material composition. The target pore diameter can be predetermined, and a particular porous layer material that includes pores having the predetermined target pore diameter can be selected and utilized to form the layer 310 included in the battery.

A predetermined pore diameter of a porous layer material configured to at least partially suppress lithium dendrite growth can include a range of pore diameters. In some embodiments, a porous AAO layer that is included in the lithium battery and at least partially suppresses lithium metal growth (or dendrite growth of other metals or metal alloys, e.g., due to contamination of the anode). includes pores having a target pore diameter of 500 nanometers In some embodiments, a porous AAO layer that is included in the lithium battery and at least partially suppresses lithium metal growth includes pores having a target pore diameter of 100 nanometers. In some embodiments, a porous AAO layer that is included in the lithium battery and at least partially suppresses lithium metal growth includes pores having a target pore diameter of 20 nanometers.

A predetermined porous layer thickness of a porous layer material that is configured to at least partially suppress lithium dendrite growth can include a range of thicknesses, e.g., approximately 2 μm-20 μm. In some embodiments, a porous AAO layer that is included in the lithium battery and at least partially suppresses lithium metal growth includes a structure having a thickness of approximately 50 micrometers. In some embodiments, a porous AAO layer that is included in the lithium battery and at least partially suppresses lithium metal growth includes a structure having a thickness of approximately 15 micrometers. In some embodiments, a porous AAO layer that is included in the lithium battery and at least partially suppresses lithium metal growth includes a structure having a thickness of approximately 1 micrometer.

In some embodiments, one or more electrolyte substances included in one or more portions of the battery 300 facilitate ionic transport through the porous layer 310. Such electrolyte substances can include one or more liquid electrolyte substances. For example, a liquid electrolyte substance can be included within the porous layer 310, where the liquid electrolyte may facilitate ionic transport, including transport of lithium ions 320, through the porous layer 310. In some embodiments, a liquid electrolyte substance is included in one or more other portions of the battery 300. For example, where one or more of anode 302 and cathode 304 includes a porous structure, a liquid electrolyte can be included within the porous structure of the respective electrode, such that the liquid electrolyte can facilitate ionic transport between the respective electrode and one or more other portions of the battery 300, including the porous layer 310.

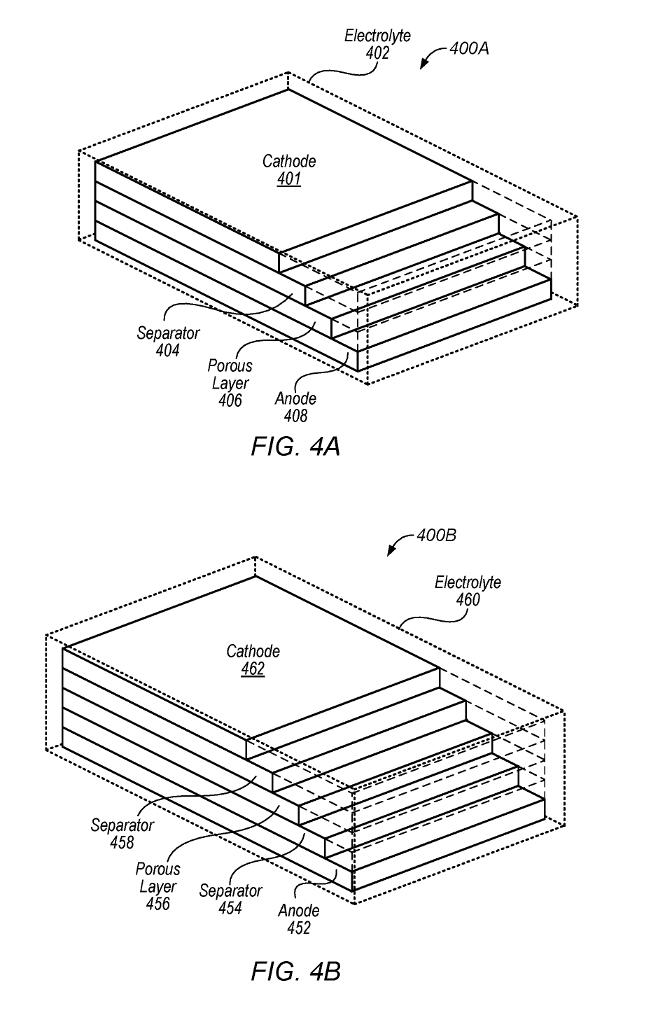

FIGS. 4A-4D illustrate perspective views of lithium batteries that include an electrochemically-neutral porous layer and at least one battery separator, according to some embodiments.

In some embodiments, a lithium battery includes a liquid electrolyte. The liquid electrolyte can be included in one or more particular portions of the battery. For example, the liquid electrolyte can be included in a battery separator, which may be located between the electrodes of the battery. In another example, one or more layers of the battery are immersed in the liquid electrolyte. In some embodiments, a lithium battery includes an electrochemically-neutral porous layer and a battery separator. The porous layer can suppress dendrite growth, and the battery separator can, in addition to separating the electrodes, shut down the battery based at least in part upon a local temperature of the separator. In addition, because the porous layer can resist, impede, or at least partially suppress lithium dendrite growth, the porous layer can resist, impede, or at least partially suppress lithium dendrites from growing through a separator located on an opposite side of the porous layer from the dendrites, so that the dendrites are suppressed from interfering with the shutdown of a battery in the event that a threshold temperature is exceeded for the separator. For example, because a porous layer can resist, impede, or at least partially suppress lithium dendrites from growing through a battery separator, a nonconductive barrier layer, typically formed by the separator when the threshold temperature is exceeded, is not compromised by lithium dendrites spanning through the separator. Additionally, the porous layer may reduce the melting propagation rate of the separator at high temperatures, and may also prevent the anode from directly contacting the cathode as the separator melts.

FIG. 4A illustrates a battery that includes a liquid electrolyte, a single battery separator, and a porous layer situated between electrodes of the battery. As shown, battery 400A includes a cathode 401 a battery separator 404, a porous layer 406, an anode 408, and a liquid electrolyte 402 in which elements 401-408 are immersed. In some embodiments (not shown), the liquid electrolyte 402 is included in the separator 404 and is not included in other layers (e.g., cathode 401, porous layer 406, anode 408) of the battery 400A. The battery separator 404 can be a separator layer. As shown, the battery 400A is configured to resist, impede, or at least partially suppress lithium dendrites, which may grow from the anode 408, from passing through the porous layer 406 and reaching separator 404. As shown, the porous layer 406 can abut a surface of the anode 408 such that the porous layer 406 is in physical contact with at least a portion of a surface of the anode 408.

In some embodiments, each layer 404, 406 comprises a thin film layer, one or more of which can be provided via any known thin film device fabrication techniques. For example, one or more of layers 404, 406 can be applied to one or more other layers in battery 400A via one or more of coating, depositing, lamination, etc. In some embodiments, one or more layers provides at least some structural support to another layer, and some layers are combined before the combination of layers is applied to one or more other portions of the battery. For example, the porous layer 406 can be laminated to the separator layer 404. The combined layers 404, 406 can then be applied to one or more of the electrodes 401, 408 via known lamination techniques. In some embodiments, one or more layers are pre-formed and stacked to form the battery 400A. For example, separator layer 404 and porous layer 406 can be formed via cutting, partitioning, stamping, etc. of one or more larger structures of separator material and porous layer material, respectively, prior to coupling the layers 404, 406 via one or more various thin film device fabrication techniques.

FIG. 4B illustrates a battery that includes a liquid electrolyte, a porous layer, and two battery separators between the electrodes of the battery, where the two battery separators are located on opposite sides of the porous layer. As shown, battery 400B includes a cathode 462, a battery separator 458, a porous layer 456, an additional battery separator 454, an anode 452, and a liquid electrolyte 460 in which portions 452-462 are immersed. In some embodiments, the liquid electrolyte 460 is included in one or more of the separators 454, 458 and is not included in other layers of the battery 400B. One or more of the battery separators 458, 454 can be a separator layer. As shown, the battery 400B is configured to resist, impede, or at least partially suppress lithium metal dendrites, which may grow from the anode 452, from passing through the porous layer 458 and reaching the battery separator 458. Furthermore, the additional battery separator 454 can provide additional shutdown protection (in addition to shutdown protection to be provided by the battery separator 458), relative to battery 400A, in the event of an overheat condition, e.g., where a local temperature exceeds a temperature threshold. As shown, the porous layer 406 can abut a surface of the anode 408, such that the porous layer is in physical contact with at least a portion of a surface of the anode 408.

In some embodiments, a lithium battery includes a solid electrolyte region that comprises a solid electrolyte layer. Such a lithium battery can include a thin film lithium ion battery. In some embodiments, a battery includes a single layer of electrolyte material. The battery can include a porous layer and separator that are arranged in the battery to separate the electrolyte region from the battery electrode from which lithium dendrites can grow, and where at least one battery separator layer is located on a distal side of the porous layer, relative to the battery electrode from which lithium dendrites can grow. As a result, any dendrites originating from the electrode can be resisted, by the porous layer, from growing through both the battery separator and the electrolyte layer.

In some embodiments, a lithium battery includes a liquid electrode that includes one or more materials in a liquid state. Such a battery can include one or more of an electrolyte layer and separator that are both located between the liquid electrode and another electrode of the battery. The electrolyte layer can include a solid electrolyte layer.

FIG. 4C illustrates a battery that includes a single electrolyte layer, a single battery separator, and a porous layer between the electrodes of the battery. At least one of the electrodes can include a liquid electrode. As shown, battery 400C includes a cathode 411, an electrolyte layer 412, a battery separator 414, a porous layer 416, and an anode 418. The electrolyte layer 412 can include a solid electrolyte layer. The battery separator 414 can be a separator layer. As shown, the battery 400C is configured to resist, impede, or at least partially suppress lithium metal dendrites, which may originate from the anode 418, from passing through the porous layer 416 and reaching separator 414. In some embodiments, one or more of electrodes 411, 418 include a liquid material. As shown, the porous layer 416 can be located adjacent to a surface of the anode 418. In some embodiments, a surface of the porous layer 416 can abut a surface of the anode 418.

In some embodiments, each layer 412, 414, 416 comprises a thin film layer, one or more of which can be provided via any known thin film device fabrication techniques. For example, one or more of layers 412, 414, 416 can be applied to one or more other layers in battery 400C via one or more of coating, depositing, lamination, etc. In some embodiments, one or more layers provides at least some structural support to another layer, and some layers are combined before the combination of layers is applied to one or more other portions of the battery. For example, the porous layer 416 can be laminated to the separator layer 414, and the solid electrolyte layer can be applied to the other surface of the separator layer 414 via one or more of coating, deposition, lamination, etc. The combined layers 412, 414, 416 can then be applied to one or more of the electrodes 411, 418 via known lamination techniques. In some embodiments, one or more layers are pre-formed and stacked to form the battery. For example, separator layer 414 and porous layer 416 can be formed, via cutting, partitioning, stamping, etc. of one or more larger structures of separator material and porous layer material, respectively, prior to coupling the layers 414, 416 via one or more various thin film device fabrication techniques.

In some embodiments (not shown), the porous layer 416 is located between the separator 414 and electrolyte layer 412, such that the electrolyte layer 412 and separator 414 are adjacent to opposite surfaces of the porous layer 416. In some embodiments (not shown), the porous layer 416 is included within the electrolyte layer 412, such that one surface of the porous layer 416 is adjacent to or abuts, electrolyte material. In some embodiments (not shown), the porous layer 416 is included within a separator 414, such that one surface of the porous layer 416 is adjacent to, or abuts, separator material.

FIG. 4D illustrates a battery that includes a single electrolyte layer, a porous layer, and two battery separators between the electrodes of the battery, where the two battery separators are located on opposite sides of the porous layer. As shown, battery 400D includes a cathode 482, an electrolyte layer 480, a battery separator 478, a porous layer 476, another battery separator 474, and an anode 408. The electrolyte layer 480 can include a solid electrolyte layer. One or more of the battery separators 478, 474 can be a separator layer. As shown, the battery 400D is configured to resist, impede, or at least partially suppress lithium dendrites, which may grow from the anode 472, from passing through the porous layer 478 and reaching separator 478. The additional separator 474 can provide additional shutdown protection, relative to battery 400C, in the event of an overheat condition where a local temperature (e.g., within battery 400D) exceeds a temperature threshold. The porous layer may reduce the melting propagation rate of the separator at high temperatures, and may also prevent the anode from directly contacting the cathode as the separator melts. As shown, the porous layer 476 can be located adjacent to, or abutting, a surface of the anode 472.

In some embodiments, one or more liquid electrolyte substances are included in one or more portions of the battery, where the one or more liquid electrolyte substances facilitate ionic transport between the one or more portions of the battery and one or more other portions of the battery. For example, in the illustrated embodiment of FIG. 4C, a liquid electrolyte can be included in porous layer 416 and separator 414, and electrolyte 412 can be a solid electrolyte layer, where the liquid electrolyte included therein facilitates ionic transport between the anode 418 and the solid electrolyte layer 412, such that ionic transport between anode 418 and cathode 411 via layers 412-416 is facilitated. In some embodiments, one or more of the cathode and the anode can comprise a porous structure in which a liquid electrolyte substance is included, where the liquid electrolyte substance facilitates ionic transport between the respective electrode and a portion of the battery in physical contact with one or more surfaces of the respective electrode. In another example, in the illustrated embodiment of FIG. 4D, a liquid electrolyte can be included in porous layer 476 and in separators 474 and 478, and electrolyte 480 can be a solid electrolyte layer, where the liquid electrolyte included therein facilitates ionic transport between the anode 472 and the solid electrolyte layer 480, such that ionic transport between anode 472 and cathode 482 via layers 474-480 is facilitated. In some embodiments, one or more of the cathode and the anode can comprise a porous structure in which a liquid electrolyte substance is included, where the liquid electrolyte substance facilitates ionic transport between the respective electrode and a portion of the battery in physical contact with one or more surfaces of the respective electrode.

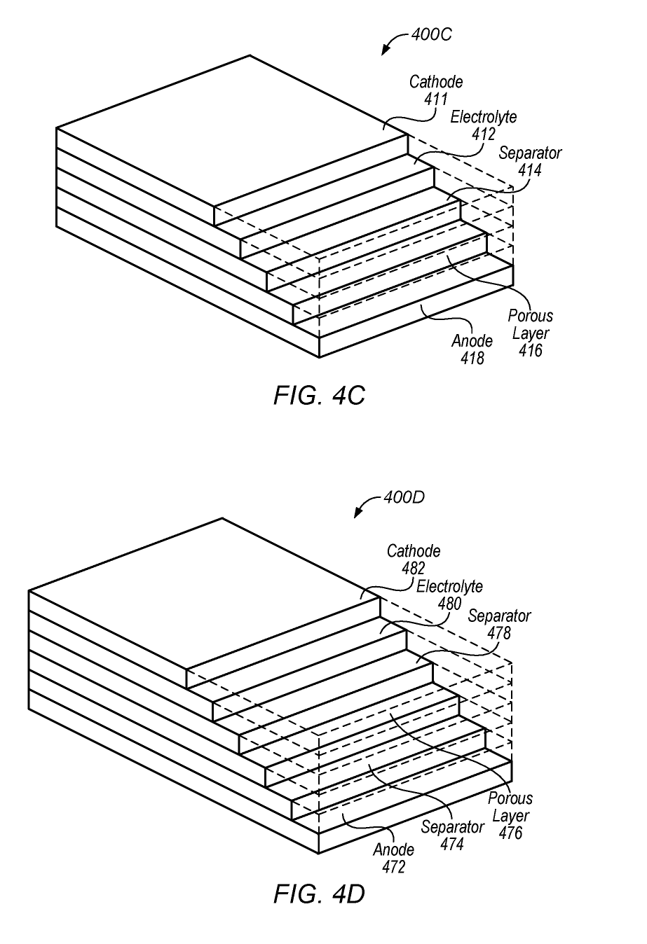

FIG. 5 illustrates a lithium battery that includes multiple layers arranged in a cylindrical coil configuration, according to some embodiments.

In some embodiments, a lithium battery, which includes an electrochemically-neutral porous layer, includes one or more particular configurations of battery components. For example, the multiple battery components in a battery, including one or more of an anode, cathode, battery separator, porous layer, electrolyte layer, etc., can be separate layers that are rolled into a cylindrical coil configuration. In some embodiments, the anode, cathode, porous layer, and a battery separator can be rolled into a cylindrical configuration of layers and immersed in a liquid electrolyte. As shown in the illustrated embodiment of FIG. 5, a battery 500 includes a cylindrical coil configuration 502 of layers, which includes battery separator layers 504, 512, a porous layer 509, an anode layer 508, and a cathode layer 506. The cylindrical coil configuration 502 of layers can be immersed in a liquid electrolyte 510. In some embodiments, the battery 500 includes a solid electrolyte layer, which can be rolled, along with the layers 504, 506, 508, 509, 512 into the cylindrical coil configuration 502. The porous layer 509 can impede or resist dendrites, which may grow from anode 508, from piercing the separator 504 and contacting the cathode layer 506, so as to cause an electrical short circuit. The porous layer 509 can also be of help during thermal failure of the separator 504 (i.e., when the separator 504 is melting). For example, the porous layer 509 may reduce the melting propagation rate of the separator at high temperatures, and may also prevent the anode layer 508 from directly contacting the cathode layer 506 as the separator melts.

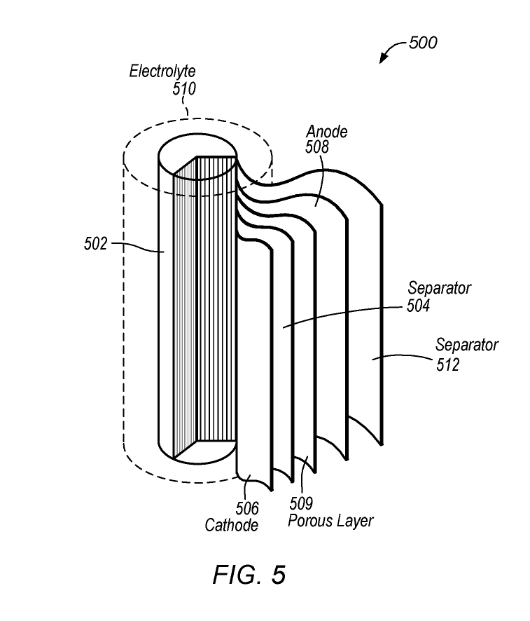

FIG. 6 illustrates a lithium battery that includes an electrochemically-neutral porous layer, according to some embodiments.

In some embodiments, a lithium battery includes a thin film lithium ion battery that includes solid electrolyte layers. The solid electrolyte in a thin film lithium ion battery can include a mixture of a solid electrolyte and one or more binder materials. For example, an electrolyte layer in the battery can include one or more of LiPON, a PVDF binder, a CMC binder, an Acrylic binder, etc.

In some embodiments, one or more of the layers in a thin film lithium ion battery can be provided via one or more various known thin film device fabrication techniques. For example, one or more of the layers in a thin film lithium ion battery, including one or more electrode layers, separator layers, electrolyte layers, porous layers, etc. can be provided in a battery via one or more of lamination, coating, deposition, etc. of the respective layers. In some embodiments, a thin film lithium ion battery is fabricated on one or more substrates.

FIG. 6 shows a thin film lithium ion battery 600, which includes a stack 601 of thin film layers provided on a substrate 602. The stack 601 includes an anode current collector 604, an anode layer 608, a porous layer 610, an electrolyte layer 612, a cathode layer 614, and a cathode current collector 618. In some embodiments, the anode layer 608 comprises a lithium metal layer, and the porous layer 610 comprises a porous AAO layer. In some embodiments, the stack 601 further includes an encapsulation layer 620 that can resist permeation into the stack 601, from an external environment, one or more various environmental elements, which can include one or more of particular matter, precipitation, moisture, etc. In some embodiments, the electrolyte layer 612 includes a solid electrolyte layer.

As shown, the battery 600 includes a thin film stack 601 of layers. The multiple layers can be applied on the substrate 602, via a thin film device fabrication technique, to form the battery 600. Some layers can be pre-formed and stacked to form at least a portion of the stack 601. Some layers can be formed on other layers that are previously applied to the substrate 602 to form at least a portion of the stack. For example, the porous layer 610 can be pre-formed from a bulk supply of porous layer material and the electrolyte layer 612 can be formed on a surface of the porous layer 610 via one or more of a coating technique, a deposition technique, a lamination technique, etc., to which the combined porous layer 610 and electrolyte layer 612 can be subsequently applied to the anode 608 via, e.g., lamination.

In some embodiments, one or more layers can provide at least some structural support of one or more other layers of the battery 600. For example, a solid electrolyte layer (e.g., electrolyte layer 612) can be at least partially structurally supported by the porous layer 610.

In some embodiments, one or more electrolyte substances are included in the porous layer 610, where the one or more electrolyte substances facilitate ionic transport between opposite surfaces of the porous layer 610 via one or more of the pores included in the porous layer. For example, a liquid electrolyte substance can be included within the porous layer 610, where the liquid electrolyte facilitates ionic transport, including the transport of lithium ions, through the porous layer 610 between the anode 608 and the electrolyte layer 612, such that ionic transport between electrodes 608, 614 via electrolyte layer 612 and porous layer 610 is facilitated. In some embodiments, a liquid electrolyte substance is included in one or more of the electrodes 608, 614. For example, where the anode 608 comprises a porous structure, a liquid electrolyte can be included in the anode 608, and the liquid electrolyte can facilitate ionic transport between the anode 608 and the porous layer 610.

It will be understood that the illustrated portions of battery 600 can be arranged in other configurations and include additional components. For example, in another configuration (not shown), battery 600 can include an electrolyte layer between porous layer 610 and anode 608, such that a surface of the porous layer that is distal from the anode 608 is in physical contact with a surface of the cathode 614. The cathode 614 can include a porous structure, and a liquid electrolyte can be included in the porous structure of both the porous layer and the cathode 614. In some embodiments, a liquid electrolyte is included only in the porous layer omitted from either of the electrodes 608, 614. In some embodiments, one or more battery separators are located in physical contact with one or more surfaces of the porous layer, and a liquid electrolyte can be included in the separators. For example, in an embodiment where a solid electrolyte layer is included between the porous layer 610 and the anode 608, a battery separator can be located between the porous layer 610 and the cathode 614, and a liquid electrolyte can be included in both the battery separator and the porous layer 610, such that the liquid electrolyte facilitates ionic transport between the solid electrolyte layer and the cathode 614 via the porous layer 610 and the battery separator, to facilitate ionic transport between the anode 608 and the cathode 614 via the solid electrolyte layer, the porous layer 610, and the battery separator. The porous layer 610 can be of additional help during thermal failure of the battery separator (i.e., when the battery separator is melting). For example, the porous layer 610 may reduce the melting propagation rate of the battery separator at high temperatures, and may also prevent the anode from directly contacting the cathode as the battery separator melts.

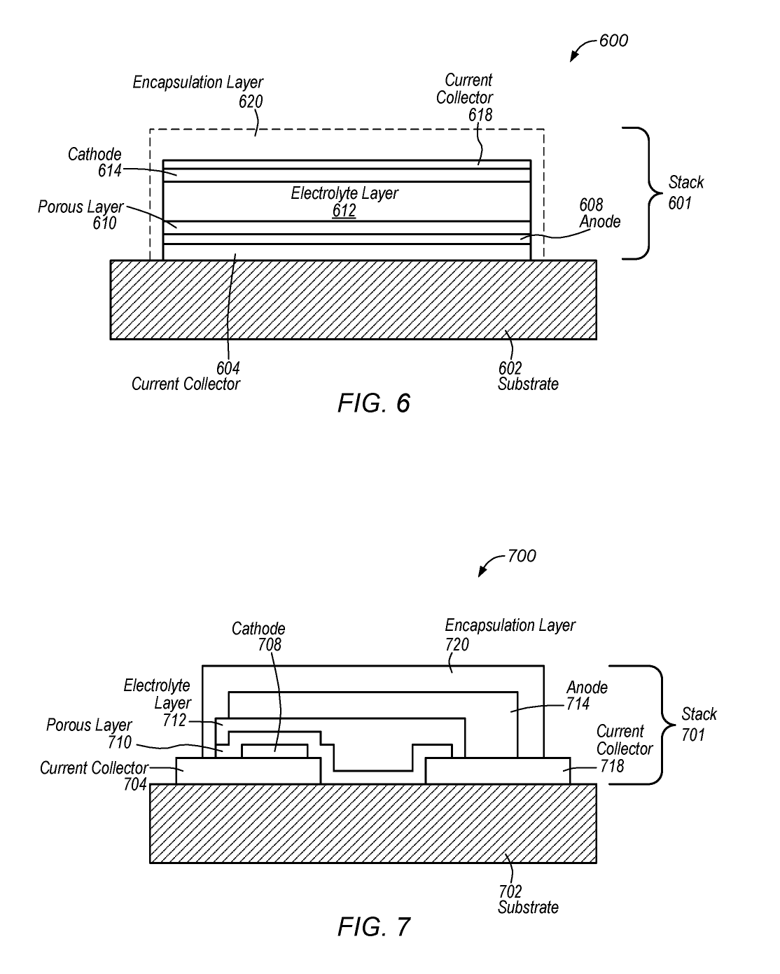

FIG. 7 illustrates a lithium battery that includes an electrochemically-neutral porous layer, according to some embodiments.

FIG. 7 shows a cross-sectional view of a thin film lithium ion battery 700 that includes a substrate 702 and a stack 701 of layers, which includes a cathode current collector 704, a cathode layer 708, a porous layer 710, an electrolyte layer 712, an anode layer 714, an anode current collector 718, and an encapsulation layer 720 applied on the substrate 702. In some embodiments, the anode layer 714 comprises a layer of lithium metal, and the porous layer comprises a porous AAO layer. In some embodiments, the electrolyte layer 612 includes a solid electrolyte layer. As shown, in some embodiments the various layers in the battery can be conforming layers, having various thicknesses, which can be applied on a substrate via one or more various known thin film device fabrication techniques.

In some embodiments, one or more electrolyte substances are included in the porous layer 710, where the one or more electrolyte substances facilitate ionic transport between opposite surfaces of the porous layer 710 via one or more of the pores included in the porous layer 710. For example, a liquid electrolyte substance can be included within the porous structure of the porous layer 710, where the liquid electrolyte facilitates ionic transport, including the transport of lithium ions, through the porous layer 710 between the anode 714 and the electrolyte layer 712, such that ionic transport between electrodes 708, 714 via electrolyte layer 712 and porous layer 710 is facilitated.

It will be understood that the illustrated portions of battery 700 can be arranged in other configurations and include additional components. For example, battery 700 can include an electrolyte layer (not shown) between porous layer 710 and cathode 708, such that a surface of the porous layer that is distal from the cathode 708 is in physical contact with a surface of the anode 714. The anode 714 can include a porous structure, and a liquid electrolyte can be included in the porous structure of both the porous layer and the anode 714. In some embodiments, a liquid electrolyte is included in the porous layer and not either of the electrodes 708, 714. In some embodiments, one or more battery separators (not shown) are located in physical contact with one or more surfaces of the porous layer, and a liquid electrolyte can be included in the battery separators. For example, where a solid electrolyte layer is included between the porous layer 710 and the cathode 708, a battery separator can be located between the porous layer 710 and the anode 714, and a liquid electrolyte can be included in both the battery separator and the porous layer 710 such that the liquid electrolyte facilitates ionic transport between the electrolyte layer and the anode 714 via the porous layer 710 and the battery separator, facilitating ionic transport between the cathode 708 and the anode 714 via the electrolyte layer, the porous layer 710, and the battery separator.

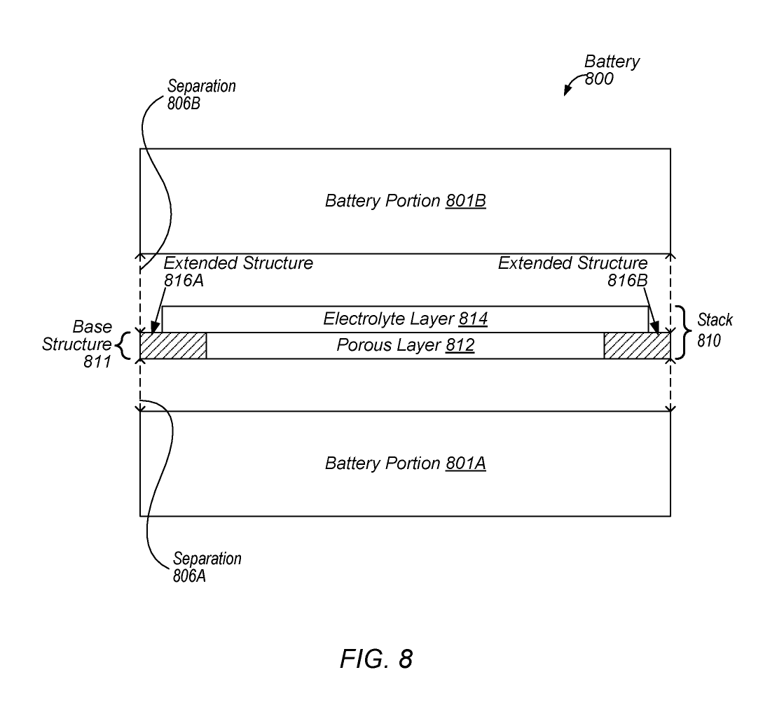

FIG. 8 illustrates an exploded view of a lithium battery that includes an electrochemically-neutral porous layer and one or more extended structures coupled to one or more sides of the porous layer, according to some embodiments. The lithium battery 800 shown in FIG. 8 can be included in any of the embodiments herein.

In some embodiments, a porous layer is coupled with an extended structure to collectively comprise a support structure that can structurally support at least one layer of solid electrolyte. The support structure can provide a skeleton structure that can support a particular shape of a solid electrolyte layer applied on one or more surfaces of the support structure. The extended structure to which the porous layer is coupled can include one or more various materials. For example, the extended structure can comprise an aluminum foil structure. The extended structure can be coupled to an outer side, also referred to interchangeably herein as an outer “edge”, of the porous layer, such that the extended structure extends from the porous layer, establishing a frame of one or more sides of the porous layer.

In some embodiments, an electrolyte layer is applied to a structure that comprises a porous layer that is coupled to an extended structure, such that the porous layer and extended structure collectively provide structural support to the electrolyte layer, which can include a solid electrolyte layer. In some embodiments, the extended structure provides the structural support. In some embodiments, the electrolyte layer is applied to a limited portion of the combined porous layer and extended structure, so that the electrolyte layer encompasses an entirety of a surface of the porous layer and at least partially encompasses a surface of the extended structure.

FIG. 8 illustrates a lithium battery 800 that is shown, via exploded view, in three portions: a first portion 801A, a second portion 801B, and a stack 810 that is separated from the portions 801A and 801B in the illustration by the respective separations 806A-B. The battery portions 801A-B can include one or more various battery components, including one or more electrodes, electrolytes, current collectors, some combination thereof, etc.

It will be understood that, in some embodiments, an illustrated separation between various portions of a battery in an illustrated exploded view of the battery are included for illustration purposes. For example, in the illustrated embodiment shown in FIG. 8, separation 806A between battery portion 801A and stack 810 in the exploded view of battery 800 may be minimal within the battery 800, such that portions or an entirety of a surface of stack 810 is in physical contact with (e.g., abuts) a surface of battery portion 801A.

As shown in FIG. 8, stack 810 includes a porous layer 812, which can include any of the porous layer embodiments included herein, and an electrolyte layer 814 that is applied to at least one surface of the porous layer 812. The electrolyte layer 814 can include a solid electrolyte layer. The porous layer 812 can include an electrolyte that is included within the porous structure of the porous layer; such an electrolyte can include a liquid electrolyte.

As further shown in FIG. 8, stack 810 includes one or more extended structures 816A, 816B that can be coupled to one or more sides of the porous layer 812 to establish a base structure 811. Although the illustrated view of the stack 810 illustrates two separate extended structures 816A, 816B coupled to opposite sides of the porous layer 812, it will be understood that, in some embodiments, a single extended structure 816 extends around all sides of the porous layer 812 such that the extended structure 816 establishes a “frame” of the porous layer and the two separate structure portions 816A, 816B shown in FIG. 8 are portions of a single continuous extended structure 816.

As shown, the electrolyte layer 814 is applied to a surface of the base structure 811, such that the base structure 811 provides structural support to the electrolyte layer 814. In some embodiments, the structure portions 816A, 816B comprise an aluminum (e.g., aluminum foil) structure that extends from one or more sides of the porous layer 812, as shown in FIG. 8. An electrolyte layer 814 may be applied to both the porous layer 812 and at least a portion of the extended structure 816 that comprises the base structure 811, so that at least a portion of the porous layer 812 and the extended structures 816A, 816B comprising the base structure 811 collectively provide structural support to the electrolyte layer 814. In some embodiments, the extended structures 816A, 816B comprise an entirety of the structural support provided to the electrolyte layer 814 by the base structure 811.

The porous layer 812, extended structures 816A and 816B, and electrolyte layer 814 can be coupled, as a stack 810, to one or more of the battery portions 801A, 801B such that battery 800 is fabricated. For example, stack 810 can be initially coupled to battery portion 801A via surfaces of at least the porous layer 812 and subsequently coupled to battery portion 801B via one or more surfaces of one or more of the electrolyte layer 814, porous layer 812, extended structures 816A and 816B, or some combination thereof. In some embodiments, the extended structures 816A, 816B at least partially restricts an electrolyte included in the porous layer 812, including a liquid electrolyte, from leaving the porous layer 812 via the sides of the porous layer that are coupled to at least one extended structure 816A, 816B.

### Battery Fabrication

Those skilled in the art will appreciate that a number of techniques may be used to fabricate a lithium battery. In some embodiments, a lithium battery that is configured to at least partially resist, impede, or suppress lithium dendrite growth between electrodes in the battery can be at least partially fabricated via various techniques.

In some embodiments, one or more sets of materials used to form one or more components of the lithium battery are provided to process as material stock. For example, where the battery includes a solid electrolyte layer, the solid electrolyte material can be provided as a powder stock, which can be mixed with one or more selected binders and applied to another formed battery layer, including the porous layer, via one or more various application processes, including coating, deposition, lamination, or some combination thereof. The porous layer can be applied to one or more portions of the battery, including one or more electrodes, via one or more various processes, including coating, depositing, laminating, etc. of the porous layer, and any layers applied to the porous layer, to the one or more battery portions.

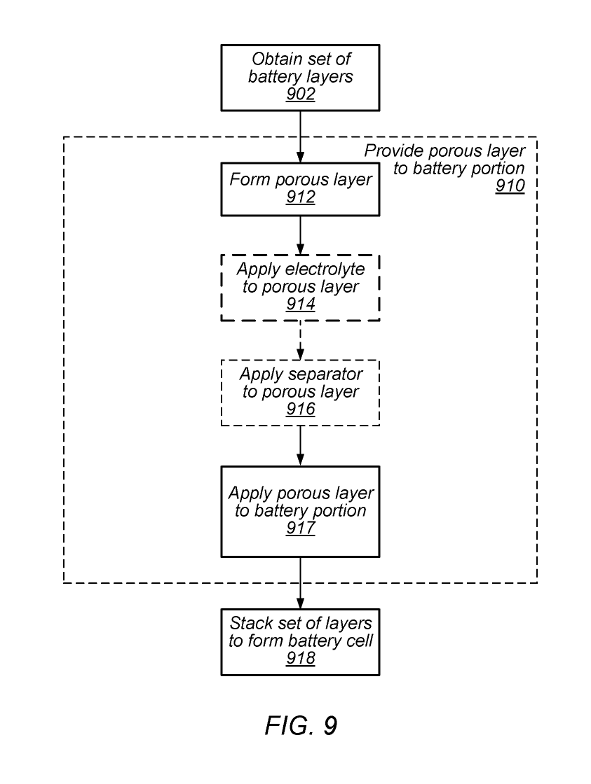

FIG. 9 illustrates a process 900 for fabricating a lithium battery, according to some embodiments. The fabricating can be controlled by one or more computer systems, which are described further below.

At block 902, a set of battery components are obtained. Battery components can include one or more battery electrodes, including one or more cathodes, anodes, etc. Battery components can include an electrochemically-neutral porous layer, an electrolyte material, a battery separator, etc. In some embodiments, one or more of the battery components are obtained as a set of material that can be used to form one or more layers of the battery. For example, the electrochemically-neutral porous layer can be obtained as a roll of layer material that can be cut, segmented, partitioned, etc. to form an individual layer for an individual battery. In another example, starting material of an electrolyte layer, including LiPON, one or more additional materials, including PVDF binders, CMC binders, acrylic binders, etc., can be obtained as a mass of material stock that can be applied to one or more surfaces, as described further below, to form one or more electrolyte layers. In some embodiments, obtaining the battery components includes obtaining an anode material that is used to form one or more anodes of the battery, where the anode material comprises lithium metal.

In some embodiments, obtaining a set of battery components includes obtaining an electrochemically-neutral porous layer material that includes a particular material composition, a pore structure of pores having a particular selected pore size and a particular selected layer material thickness. For example, the electrochemically-neutral porous layer material can include an anodic aluminum oxide layer material that includes pores having an approximate pore diameter that does not exceed approximately 100 nanometers, and a having a thickness of 1-50 micrometers. In some embodiments, the pores in the layer material include pores having an approximate pore diameter between 10 nanometers and 100 nanometers, and in other embodiments the pores in the layer material may have an approximate port diameter between 20 nanometers and 500 nanometers.

At block 910, the electrochemically-neutral porous layer is provided between the electrodes of the battery. Such providing can include applying the porous layer to a portion of the battery that includes a single electrode, and subsequently applying the other electrode to the portion that includes the applied porous layer.

As shown by blocks 912, 914, 916, and 917, the providing can include various elements. As shown at block 912, the electrochemically-neutral porous layer can be formed from the obtained layer material. Such layer formation can include partitioning, cutting, etc. an obtained set of layer material stock into an individual layer. In some embodiments, forming the layer includes applying at least some of the layer material to a substrate, carrier film, etc. Such applying of material to form a layer can include any known method for forming a layer from a material stock, including atomic layer deposition, coating of materials, lamination of materials, etc.

At block 914, where the lithium battery being fabricated is to comprise at least one solid electrolyte layer, at least one solid electrolyte layer material can be applied to at least one surface of the porous layer, such that at least one solid electrolyte layer is formed on the at least one surface of the porous layer. The solid electrolyte material can include any known solid electrolytes, including LiPON, a mixture that includes one or more of PVDF binders, CMC binders, acrylic binders, etc. Applying solid electrolyte layer material to a surface of the porous layer can include one or more of coating the material over at least a particular selected portion of the porous layer to form the solid electrolyte layer, depositing the material over at least a particular selected portion of the porous layer to form the solid electrolyte layer, laminating the material on at least a particular selected portion of the porous layer to form the solid electrolyte layer, etc.

Applying the solid electrolyte material to a particular selected portion of the porous layer can result in forming a solid electrolyte layer that extends over a selected particular portion of the porous layer in a particular selected pattern. In some embodiments, applying the solid electrolyte material to the porous layer results in the formation of a solid electrolyte layer that is at least partially structurally supported by the porous layer. For example, the porous layer material can provide a structural skeleton structure that supports a particular shape of the solid electrolyte layer applied on one or more surfaces of the porous layer. In some embodiments, one or more solid electrolyte layers are applied on multiple surfaces of the porous layer, such that multiple separate solid electrolyte layers are formed.

At block 916, one or more battery separator materials are applied to one or more sides of the porous layer, such that one or more battery separator layers are formed. Applying battery separator material to a side of the porous layer can include one or more of coating the material over at least a particular selected portion of the porous layer to form the solid electrolyte layer, depositing the material over at least a particular selected portion of the porous layer to form the solid electrolyte layer, laminating the material on at least a particular selected portion of the porous layer to form the solid electrolyte layer, etc.

At block 917, the porous layer is applied to a portion of the lithium battery. The portion of the lithium battery can include one or more electrodes, such that applying the porous layer includes applying at least a portion of the porous layer directly to at least one surface of at least one electrode.

At block 914, a solid electrolyte layer is applied to at least one surface of the porous layer, and applying the porous layer to a battery portion includes applying the combined porous layer and solid electrolyte layer to the battery portion, subsequent to forming the solid electrolyte layer on one or more surfaces of the porous layer. Applying the porous layer to the battery portion can include applying a surface of the porous layer that is distal from the surface on which the solid electrolyte layer is formed, to the battery portion, such that the porous layer is located between the solid electrolyte layer and the battery portion.

At block 916, in some embodiments, the battery separator is applied to at least one surface of the porous layer. At block 917, the method includes applying the porous layer to a battery portion, which includes applying the combined porous layer and battery separator to the battery portion subsequent to applying the battery separator on one or more surfaces of the porous layer. Applying the porous layer to the battery portion can include applying a surface of the porous layer that is distal from the surface on which the battery separator is applied, to the battery portion, such that the porous layer is located between the battery separator and the battery portion.

Applying the porous layer to the battery portion can include one or more of coating the porous layer over at least a particular selected portion of the battery portion, depositing the porous layer over at least a particular selected portion of the battery portion, laminating the porous layer over at least a particular selected portion of the battery portion, etc.

At block 918, a remainder of the battery components is applied to the battery portion, such that the battery is fabricated. The application can include stacking multiple separate layers over the porous layer that is applied to the battery portion. In some embodiments, the application includes applying an electrode, current collector, thin film layer, encapsulation layer, or some combination thereof over the applied porous layer to complete the fabrication of the battery.

In some embodiments, fabricating the lithium battery includes applying a liquid electrolyte to one or more portions of the battery. For example, one or more of forming the porous layer (block 912), applying the separator to the porous layer 916, applying the porous layer to a battery portion (block 917), and applying a remainder of battery components to the battery portion (block 912) can include applying a liquid electrolyte substance to one or more of the porous layer, the battery separator, one or more of the electrodes, or some combination thereof.

### Electronic Device Examples

Embodiments of electronic devices in which embodiments of batteries as described herein may be used are described.

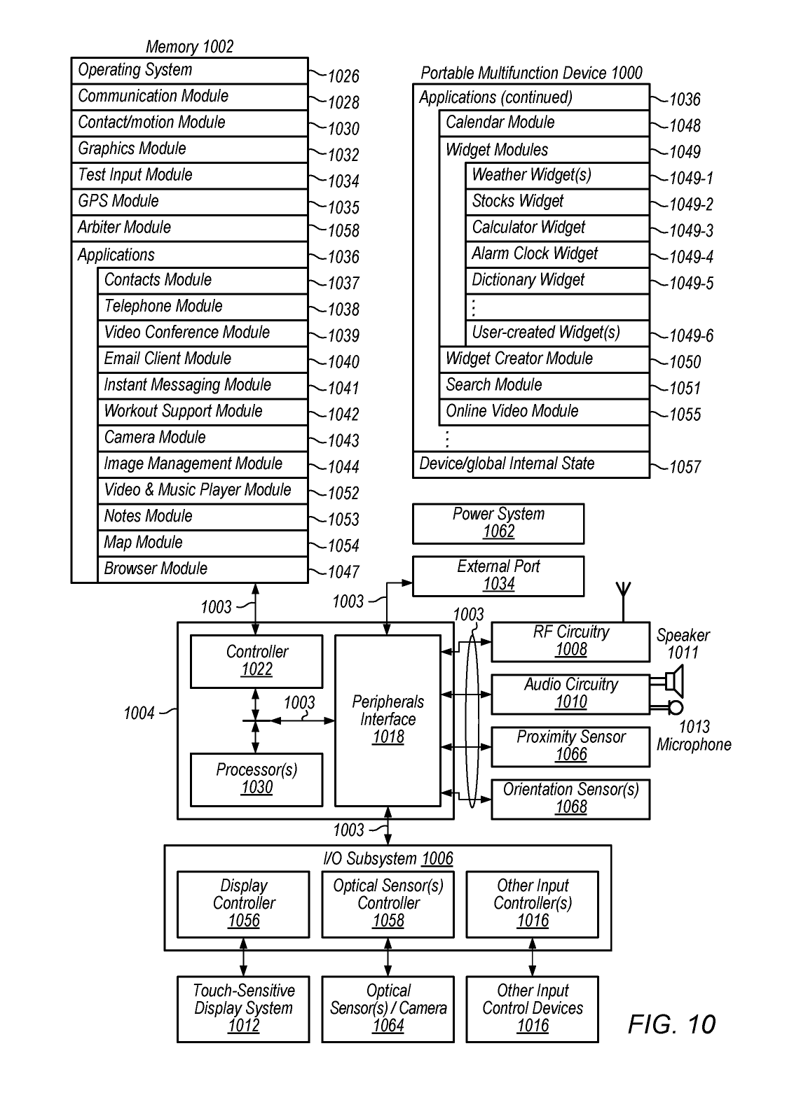

Attention is now directed toward embodiments of portable devices with cameras. FIG. 10 illustrates device 1000, which may be powered by one or more of the batteries described above with reference to FIGS. 1-8.

Device 1000 is a multifunction device (e.g., a computing device) that may include memory 1002 (that may include one or more computer readable storage mediums), memory controller 1022, one or more processing units (CPU's) 1020, peripherals interface 1018, RF circuitry 1008, audio circuitry 1010, speaker 1011, touch-sensitive display system 1012, microphone 1013, input/output (I/O) subsystem 1006, other input or control devices 1016, and external port 1024. Device 1000 may include one or more optical sensors 1064. These components may communicate over one or more communication buses or signal lines 1003.

Memory 1002 may include high-speed random access memory and may also include non-volatile memory, such as one or more magnetic disk storage devices, flash memory devices, or other non-volatile solid-state memory devices. Access to memory 1002 by other components of device 1000, such as CPU 1020 and the peripherals interface 1018, may be controlled by memory controller 1022.

Peripherals interface 1018 can be used to couple input and output peripherals of the device to CPU 1020 and memory 1002. The one or more processors 1020 run or execute various software programs and/or sets of instructions stored in memory 1002 to perform various functions for device 1000 and to process data.

In some embodiments, peripherals interface 1018, CPU 1020, and memory controller 1022 may be implemented on a single chip, such as chip 1004. In some other embodiments, they may be implemented on separate chips.

RF (radio frequency) circuitry 1008 receives and sends RF signals, also called electromagnetic signals. RF circuitry 1008 converts electrical signals to/from electromagnetic signals and communicates with communications networks and other communications devices via the electromagnetic signals.

Audio circuitry 1010, speaker 1011, and microphone 1013 provide an audio interface between a user and device 1000. Audio circuitry 1010, which can include one or more audio communication interfaces, receives audio data from peripherals interface 1018, converts the audio data to an electrical signal, and transmits the electrical signal to speaker 1011. Speaker 1011 converts the electrical signal to human-audible sound waves. Audio circuitry 1010 also receives electrical signals converted by microphone 1013 from sound waves. Audio circuitry 1010 converts the electrical signal to audio data and transmits the audio data to peripherals interface 1018 for processing. Audio data may be retrieved from and/or transmitted to memory 102 and/or RF circuitry 1008 by peripherals interface 1018. In some embodiments, audio circuitry 1010 also includes a headset jack (e.g., 1012, FIG. 10). The headset jack provides an interface between audio circuitry 1010 and removable audio input/output peripherals, such as output-only headphones or a headset with both output (e.g., a headphone for one or both ears) and input (e.g., a microphone).

I/O subsystem 1006 couples input/output peripherals on device 1000, such as touch screen 1012 and other input control devices 1016, to peripherals interface 1018. I/O subsystem 1006 may include display controller 1056 and one or more input controllers 1060 for other input or control devices. The one or more input controllers 160 receive/send electrical signals from/to other input or control devices 1016. The other input control devices 1016 may include physical buttons (e.g., push buttons, rocker buttons, etc.), dials, slider switches, joysticks, click wheels, and so forth. In some alternative embodiments, input controller(s) 1060 may be coupled to any (or none) of the following: a keyboard, infrared port, USB port, and a pointer device such as a mouse. The one or more buttons (e.g., 1008, FIG. 10) may include an up/down button for volume control of speaker 1011 and/or microphone 1013. The one or more buttons may include a push button (e.g., 1006, FIG. 10).

Touch-sensitive display 1012 provides an input interface and an output interface between the device and a user. Display controller 1056 receives and/or sends electrical signals from/to touch screen 1012. Touch screen 1012 displays visual output to the user. The visual output may include graphics, text, icons, video, and any combination thereof (collectively termed “graphics”). In some embodiments, some or all of the visual output may correspond to user-interface objects.

Touch screen 1012 has a touch-sensitive surface, sensor or set of sensors that accepts input from the user based on haptic and/or tactile contact. Touch screen 1012 and display controller 1056 (along with any associated modules and/or sets of instructions in memory 1002) detect contact (and any movement or breaking of the contact) on touch screen 1012 and converts the detected contact into interaction with user-interface objects (e.g., one or more soft keys, icons, web pages or images) that are displayed on touch screen 1012. In an example embodiment, a point of contact between touch screen 1012 and the user corresponds to a finger of the user.

Device 1000 also includes power system 1062 for powering the various components. Power system 1062 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 1000 may also include one or more optical sensors or cameras 1064. FIG. 10 shows an optical sensor coupled to optical sensor controller 1058 in I/O subsystem 1006. Optical sensor 1064 may include charge-coupled device (CCD) or complementary metal-oxide semiconductor (CMOS) phototransistors. Optical sensor 1064 receives light from the environment, projected through one or more lens, and converts the light to data representing an image. In conjunction with imaging module 1043 (also called a camera module), optical sensor 1064 may capture still images or video. In some embodiments, an optical sensor is located on the back of device 1000, opposite touch screen display 1012 on the front of the device, so that the touch screen display may be used as a viewfinder for still and/or video image acquisition. In some embodiments, another optical sensor is located on the front of the device so that the user's image may be obtained for videoconferencing while the user views the other videoconference participants on the touch screen display.

Device 1000 may also include one or more proximity sensors 1066. FIG. 10 shows proximity sensor 1066 coupled to peripherals interface 1018. Alternatively, proximity sensor 1066 may be coupled to input controller 1060 in I/O subsystem 1006. In some embodiments, the proximity sensor turns off and disables touch screen 1012 when the multifunction device is placed near the user's ear (e.g., when the user is making a phone call).

Device 1000 includes one or more orientation sensors 1068. In some embodiments, the one or more orientation sensors include one or more accelerometers (e.g., one or more linear accelerometers and/or one or more rotational accelerometers).

In some embodiments, the software components stored in memory 1002 include operating system 1026, communication module (or set of instructions) 1028, contact/motion module (or set of instructions) 1030, graphics module (or set of instructions) 1032, text input module (or set of instructions) 1034, Global Positioning System (GPS) module (or set of instructions) 1035, arbiter module 1057 and applications (or sets of instructions) 1036. Furthermore, in some embodiments memory 1002 stores device/global internal state 1057. Device/global internal state 1057 includes one or more of: active application state, indicating which applications, if any, are currently active; display state, indicating what applications, views or other information occupy various regions of touch screen display 1012; sensor state, including information obtained from the device's various sensors and input control devices 1016; and location information concerning the device's location and/or attitude.

Communication module 1028 facilitates communication with other devices over one or more external ports 1024 and also includes various software components for handling data received by RF circuitry 1008 and/or external port 1024. External port 1024 (e.g., Universal Serial Bus (USB), FIREWIRE, etc.) is adapted for coupling directly to other devices or indirectly over a network (e.g., the Internet, wireless LAN, etc.).

Contact/motion module 1030 may detect contact with touch screen 1012 (in conjunction with display controller 1056) and other touch sensitive devices (e.g., a touchpad or physical click wheel). Contact/motion module 1030 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 1030 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, contact/motion module 1030 and display controller 1056 detect contact on a touchpad.

Graphics module 1032 includes various known software components for rendering and displaying graphics on touch screen 1012 or other display, including components for changing the intensity of graphics that are displayed. In some embodiments, graphics module 1032 stores data representing graphics to be used. Each graphic may be assigned a corresponding code. Graphics module 1032 receives, from applications etc., one or more codes specifying graphics to be displayed along with, if necessary, coordinate data and other graphic property data, and then generates screen image data to output to display controller 1056.

Text input module 1034, which may be a component of graphics module 1032, provides soft keyboards for entering text in various applications (e.g., contacts 1037, e-mail 1040, IM 141, browser 1047, and any other application that needs text input).

GPS module 1035 determines the location of the device and provides this information for use in various applications (e.g., to telephone 1038 for use in location-based dialing, to camera module 1043 as picture/video metadata, and to applications that provide location-based services such as weather widgets, local yellow page widgets, and map/navigation widgets).

Applications 1036 may include the following modules (or sets of instructions), or a subset or superset thereof:
contacts module 1037 (sometimes called an address book or contact list);
telephone module 1038;
video conferencing module 1039;
e-mail client module 1040;
instant messaging (IM) module 1041;
workout support module 1042;
camera module 1043 for still and/or video images;
image management module 1044;
browser module 1047;
calendar module 1048;
widget modules 1049, which may include one or more of: weather widget 1049-1, stocks widget 1049-2, calculator widget 1049-3, alarm clock widget 1049-4, dictionary widget 1049-5, and other widgets obtained by the user, as well as user-created widgets 1049-6;
widget creator module 1050 for making user-created widgets 1049-6;
search module 1051;
video and music player module 1052, which may be made up of a video player
module and a music player module;
notes module 1053;
map module 1054; and/or
online video module 1055.

Examples of other applications 1036 that may be stored in memory 1002 include other word processing applications, other image editing applications, drawing applications, presentation applications, JAVA-enabled applications, encryption, digital rights management, voice recognition, and voice replication.

In conjunction with touch screen 1012, display controller 1056, contact module 1030, graphics module 1032, and text input module 1034, contacts module 1037 may be used to manage an address book or contact list (e.g., stored in application internal state 1092 of contacts module 1037 in memory 1002), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 1038, video conference 1039, e-mail 1040, or IM 1041; and so forth.

In conjunction with RF circuitry 1008, audio circuitry 1010, speaker 1011, microphone 1013, touch screen 1012, display controller 1056, contact module 1030, graphics module 1032, and text input module 1034, telephone module 1038 may be used to enter a sequence of characters corresponding to a telephone number, access one or more telephone numbers in address book 1037, modify a telephone number that has been entered, dial a respective telephone number, conduct a conversation and disconnect or hang up when the conversation is completed. As noted above, the wireless communication may use any of a variety of communications standards, protocols and technologies.

In conjunction with RF circuitry 1008, audio circuitry 1010, speaker 1011, microphone 1013, touch screen 1012, display controller 1056, optical sensor 1064, optical sensor controller 1058, contact module 1030, graphics module 1032, text input module 1034, contact list 1037, and telephone module 1038, videoconferencing module 109 includes executable instructions to initiate, conduct, and terminate a video conference between a user and one or more other participants in accordance with user instructions.

In conjunction with RF circuitry 1008, touch screen 1012, display controller 1056, contact module 1030, graphics module 1032, and text input module 1034, e-mail client module 1040 includes executable instructions to create, send, receive, and manage e-mail in response to user instructions. In conjunction with image management module 1044, e-mail client module 1040 makes it very easy to create and send e-mails with still or video images taken with camera module 1043.

In conjunction with RF circuitry 1008, touch screen 1012, display controller 1056, contact module 1030, graphics module 1032, and text input module 1034, the instant messaging module 1041 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XIVIPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 1008, touch screen 1012, display controller 1056, contact module 1030, graphics module 1032, text input module 1034, GPS module 1035, map module 1054, and music player module 1046, workout support module 1042 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 1012, display controller 1056, optical sensor(s) 1064, optical sensor controller 1058, contact module 1030, graphics module 1032, and image management module 1044, camera module 1043 includes executable instructions to capture still images or video (including a video stream) and store them into memory 1002, modify characteristics of a still image or video, or delete a still image or video from memory 1002.

In conjunction with touch screen 1012, display controller 1056, contact module 1030, graphics module 1032, text input module 1034, and camera module 1043, image management module 1044 includes executable instructions to arrange, modify (e.g., edit), or otherwise manipulate, label, delete, present (e.g., in a digital slide show or album), and store still and/or video images.

In conjunction with RF circuitry 1008, touch screen 1012, display system controller 1056, contact module 1030, graphics module 1032, and text input module 1034, browser module 1047 includes executable instructions to browse the Internet in accordance with user instructions, including searching, linking to, receiving, and displaying web pages or portions thereof, as well as attachments and other files linked to web pages.

In conjunction with RF circuitry 1008, touch screen 1012, display system controller 1056, contact module 1030, graphics module 1032, text input module 1034, e-mail client module 1040, and browser module 1047, calendar module 1048 includes executable instructions to create, display, modify, and store calendars and data associated with calendars (e.g., calendar entries, to do lists, etc.) in accordance with user instructions.

In conjunction with RF circuitry 1008, touch screen 1012, display system controller 1056, contact module 1030, graphics module 1032, text input module 1034, and browser module 1047, widget modules 1049 are mini-applications that may be downloaded and used by a user (e.g., weather widget 1049-1, stocks widget 1049-2, calculator widget 10493, alarm clock widget 1049-4, and dictionary widget 1049-5) or created by the user (e.g., user-created widget 1049-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 1008, touch screen 1012, display system controller 1056, contact module 1030, graphics module 1032, text input module 1034, and browser module 1047, the widget creator module 1050 may be used by a user to create widgets (e.g., turning a user-specified portion of a web page into a widget).

In conjunction with touch screen 1012, display system controller 1056, contact module 1030, graphics module 1032, and text input module 1034, search module 1051 includes executable instructions to search for text, music, sound, image, video, and/or other files in memory 1002 that match one or more search criteria (e.g., one or more user-specified search terms) in accordance with user instructions.

In conjunction with touch screen 1012, display system controller 1056, contact module 1030, graphics module 1032, audio circuitry 1010, speaker 1011, RF circuitry 1008, and browser module 1047, video and music player module 1052 includes executable instructions that allow the user to download and play back recorded music and other sound files stored in one or more file formats, such as MP3 or AAC files, and executable instructions to display, present or otherwise play back videos (e.g., on touch screen 1012 or on an external, connected display via external port 1024). In some embodiments, device 1000 may include the functionality of an MP3 player.

In conjunction with touch screen 1012, display controller 1056, contact module 1030, graphics module 1032, and text input module 1034, notes module 1053 includes executable instructions to create and manage notes, to do lists, and the like in accordance with user instructions.

In conjunction with RF circuitry 1008, touch screen 1012, display system controller 1056, contact module 1030, graphics module 1032, text input module 1034, GPS module 1035, and browser module 1047, map module 1054 may be used to receive, display, modify, and store maps and data associated with maps (e.g., driving directions; data on stores and other points of interest at or near a particular location; and other location-based data) in accordance with user instructions.

In conjunction with touch screen 1012, display system controller 1056, contact module 1030, graphics module 1032, audio circuitry 1010, speaker 1011, RF circuitry 1008, text input module 1034, e-mail client module 1040, and browser module 1047, online video module 1055 includes instructions that allow the user to access, browse, receive (e.g., by streaming and/or download), play back (e.g., on the touch screen or on an external, connected display via external port 1024), send an e-mail with a link to a particular online video, and otherwise manage online videos in one or more file formats, such as H.264. In some embodiments, instant messaging module 1041, rather than e-mail client module 1040, is used to send a link to a particular online video.

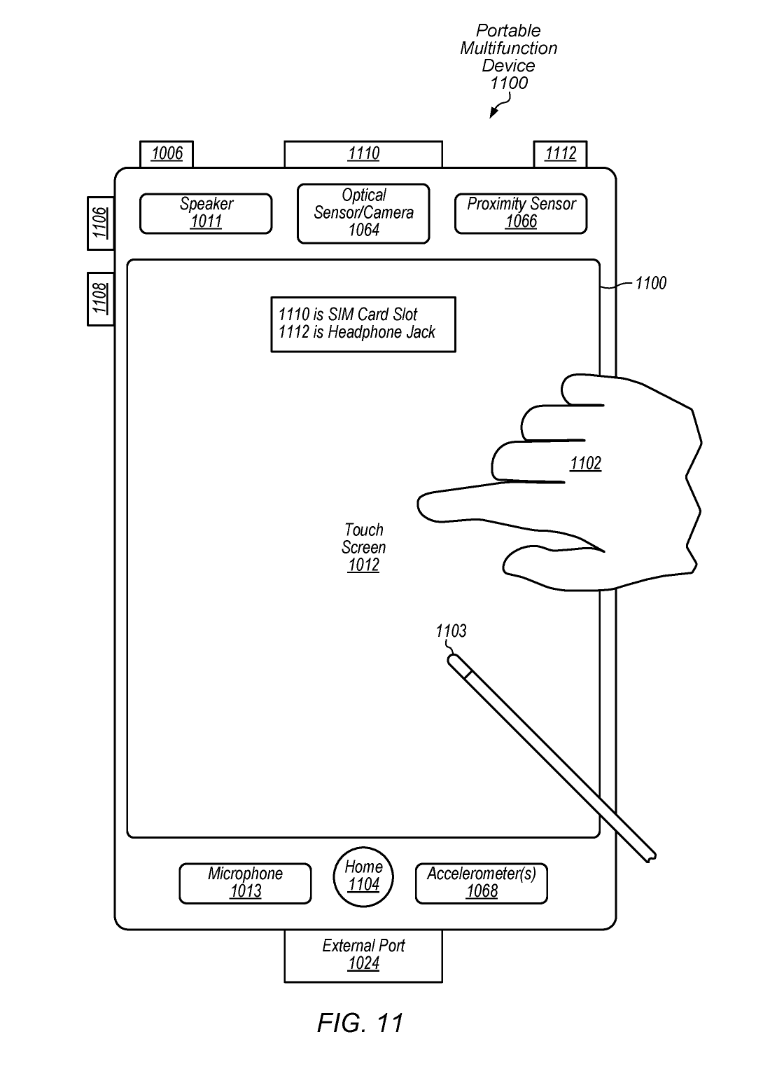

FIG. 11 illustrates a portable electronic device 1100 that may be powered by one or more of the batteries described above with reference to FIGS. 1-8. Touch screen 1012 may display one or more graphics, also referred to herein as graphical representations, icons, etc., within user interface (UI) 1100. UI 1100 can include a graphical user interface (GUI). In this embodiment, as well as others described below, a user may select one or more of the graphics by making a gesture on the graphics, for example, with one or more fingers 1102 (not drawn to scale in the Figure) or one or more styluses 1103 (not drawn to scale in the figure).

Device 1100 may also include one or more physical buttons, such as “home” or menu button 1104. As described previously, menu button 1104 may be used to navigate to any application 1036 in a set of applications that may be executed on device 1000. Alternatively, in some embodiments, the menu button is implemented as a soft key in a graphics user interface (GUI) displayed on touch screen 1012.

In one embodiment, device 1000 includes touch screen 1012, menu button 1104, push button 1106 for powering the device on/off and locking the device, volume adjustment button(s) 1108, Subscriber Identity Module (SIM) card slot 1110, head set jack 1112, and docking/charging external port 1024. Push button 1106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 1000 also may accept verbal input for activation or deactivation of some functions through microphone 1013.

It should be noted that, although many of the examples herein are given with reference to optical sensor/camera 1064 (on the front of a device), a rear-facing camera or optical sensor that is pointed opposite from the display may be used instead of or in addition to an optical sensor/camera 1064 on the front of a device.

### Example Computer System

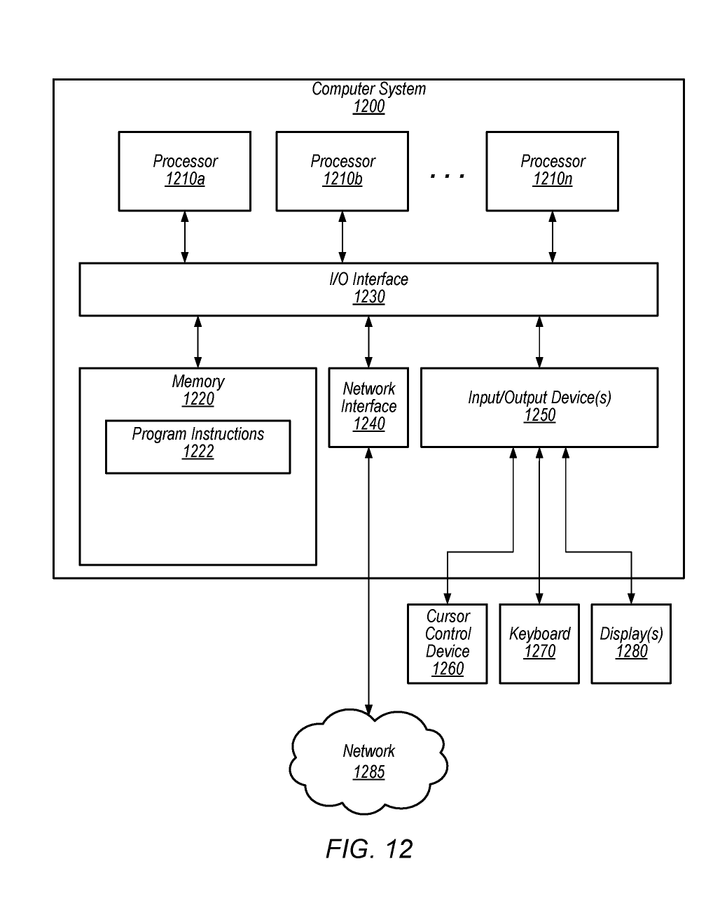

FIG. 12 illustrates an example computer system 1200 that may be powered by one or more of the batteries described above with reference to FIGS. 1-8. In different embodiments, computer system 1200 may be any of various types of devices, including, but not limited to, a personal computer system, desktop computer, laptop, notebook, tablet, slate, pad, or netbook computer, cell phone, smartphone, PDA, portable media device, mainframe computer system, handheld computer, workstation, network computer, a camera or video camera, a set top box, a mobile device, a consumer device, video game console, handheld video game device, application server, storage device, a television, a video recording device, a peripheral device such as a switch, modem, router, or in general any type of computing or electronic device.

Various embodiments of one or more functional components of an electronic device, a process for fabricating a lithium battery, etc., as described herein, may be executed in one or more computer systems 1200, which may interact with various other devices. Note that any component, action, or functionality described above with respect to FIG. 1-11 may be implemented on one or more computers configured as computer system 1200 of FIG. 12, according to various embodiments. In the illustrated embodiment, computer system 1200 includes one or more processors 1210 coupled to a system memory 1220 via an input/output (I/O) interface 1230. Computer system 1200 further includes a network interface 1240 coupled to I/O interface 1230, and one or more input/output devices 1250, such as cursor control device 1260, keyboard 1270, and display(s) 1280. In some cases, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

System memory 1220 may be configured to store camera control program instructions 1222 and/or voice communication control data accessible by processor 1210. In various embodiments, system memory 1220 may be implemented using any suitable memory technology, such as static random access memory (SRAM), synchronous dynamic RAM (SDRAM), nonvolatile/Flash-type memory, or any other type of memory. In the illustrated embodiment, program instructions 1222 may be configured to implement a point-to-point voice communication application incorporating any of the functionality described above. Additionally, program instructions 1222 of memory 1220 may include any of the information or data structures described above. In some embodiments, program instructions and/or data may be received, sent or stored upon different types of computer-accessible media or on similar media separate from system memory 1220 or computer system 1200. While computer system 1200 is described as implementing the functionality of functional blocks of previous Figures, any of the functionality described herein may be implemented via such a computer system.

In one embodiment, I/O interface 1230 may be configured to coordinate I/O traffic between processor 1210, system memory 1220, and any peripheral devices in the device, including network interface 1240 or other peripheral interfaces, such as input/output devices 1250. In some embodiments, I/O interface 1230 may perform any necessary protocol, timing or other data transformations to convert data signals from one component (e.g., system memory 1220) into a format suitable for use by another component (e.g., processor 1210). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. Also, in some embodiments some or all of the functionality of I/O interface 1230, such as an interface to system memory 1220, may be incorporated directly into processor 1210.

Network interface 1240 may be configured to allow data to be exchanged between computer system 1200 and other devices attached to a network 1285 (e.g., carrier or agent devices) or between nodes of computer system 1200. Network 1285 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1240 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1250 may, in some embodiments, include one or more display terminals, keyboards, keypads, touchpads, scanning devices, voice or optical recognition devices, or any other devices suitable for entering or accessing data by one or more computer systems 1200. Multiple input/output devices 1250 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1240.

As shown in FIG. 12, memory 1220 may include program instructions 1222, which may be processor-executable to implement any element or action described above. In one embodiment, the program instructions may implement the methods described above. In other embodiments, different elements and data may be included. Note that data may include any data or information described above.

The methods described herein, e.g., the method described in FIG. 9 and corresponding paragraphs, may be implemented via software, hardware, or a combination thereof in different embodiments (e.g., automated assembly of a battery). In addition, the order of execution of some the blocks of the methods (e.g., the method described in FIG. 9) may be changed, and various elements may be added, reordered, combined, omitted, modified, etc.

Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A battery, comprising:
a first electrode;
a second electrode; and
a porous layer positioned between the first electrode and the second electrode, wherein the porous layer resists dendrite growth from the first electrode through the porous layer to the second electrode and permits ion transport through the porous layer from the first electrode to the second electrode.

2. The battery of claim 1, wherein:
the porous layer comprises a porous layer that includes a plurality of pores sized to permit ionic transport through the porous layer and to resist dendrite growth through the porous layer.

3. The battery of claim 1, wherein the first electrode comprises lithium.

4. The battery of claim 1, further comprising at least one battery separator coupled to at least one side of the porous layer, the at least one battery separator configured to inhibit ionic transport between the electrodes of the battery responsive to a temperature of the at least one battery separator exceeding a temperature threshold.

5. The battery of claim 1, wherein the porous layer has a thickness dimension that is less than or equal to approximately 20 microns.

6. The battery of claim 1, wherein the battery comprises at least one solid electrolyte that is located on at least one side of the porous layer.

7. The battery of claim 6, wherein:
the at least one solid electrolyte comprises a solid electrolyte layer that is applied to at least one side of the porous layer, such that the porous layer at least partially structurally supports the solid electrolyte layer; and
the porous layer is applied to at least one side of at least one of the electrodes.

8. The battery of claim 1, wherein the first electrode comprises a first electrically conducting thin film and that includes lithium, the second electrode comprises a second electrically conducting thin film, and the porous layer comprises a porous thin film.

9. A method, comprising:
assembling a first electrode, a second electrode positioned opposite the first electrode and an electrolyte positioned between the first electrode and the second electrode;
providing a porous layer between the first electrode and the second electrode and contacting the electrolyte, wherein the porous layer is configured to permit ionic transport from the first electrode to the second electrode through the porous layer, and to resist one or more dendrites attach to the first electrode from extending from a first surface of the porous layer situated opposite the first electrode through the porous layer to a second surface of the proximate layer situated opposite the second electrode.

10. The method of claim 9, wherein the porous layer comprises a plurality of pores that are sized to facilitate transport of ions that originate at the first electrode through the porous layer via the plurality of pores, and to resist one or more dendrites that originate at the first electrode from passing through the porous layer via the plurality of apertures.

11. The method of claim 9, wherein the first electrode comprises lithium.

12. The method of claim 9, wherein providing the porous layer between the first electrode and the second electrode comprises laminating at least the porous layer to at least one battery separator, wherein the at least one battery separator is configured to inhibit ion transport between the first electrode and the second electrode responsive to a temperature of the at least one battery separator exceeding a threshold temperature.

13. The method of claim 9, wherein providing the porous layer between the first electrode and the second electrode comprises:
applying a solid electrolyte layer to at least one side of the porous layer, such that the porous layer at least partially structurally supports the solid electrolyte layer; and
subsequent to applying the solid electrolyte layer to the at least one side of the porous layer, applying the porous layer to at least one of the first electrode and the second electrode on at least one other side of the porous layer, wherein the solid electrolyte layer is to conduct ions between the first electrode and the second electrode via at least one portion of the porous layer.

14. The method of claim 13, wherein applying the solid electrolyte layer to at least one side of the porous layer comprises performing at least one of:
laminating the solid electrolyte layer to at least one side of the porous layer;
depositing the solid electrolyte layer on at least one side of the porous layer; or
coating the solid electrolyte layer on at least one side of the porous layer.

15. The method of claim 9, wherein providing the porous layer between the first electrode and the second electrode comprises laminating the porous layer to the first electrode or to the second electrode.

16. The method of claim 9, wherein the porous layer comprises pores having a maximum pore diameter of approximately 200 nanometers.

17. A device comprising:
at least one functional component configured to consume electrical power; and
a battery configured to provide electrical power support to the at least one functional component, wherein the battery includes a porous layer situated between a first electrode and a second electrode and configured to permit ionic transport through the porous layer and to resist dendrite growth through the porous layer of one or more dendrites that attach to a first electrode of the battery.

18. The portable electronic device of claim 17, wherein the porous layer comprises a porous anodic aluminum oxide (AAO) layer that comprises a plurality of pores.

19. The portable electronic device of claim 17, wherein the porous layer comprises a plurality of pores that extend from one face of the porous layer to an opposite face of the porous layer and wherein the diameter of each pore is at least approximately 20 nanometers and less than or equal to approximately 200 nanometers.

20. The portable electronic device of claim 17, wherein:
the battery comprises at least one battery separator coupled to at least one side of the porous layer; and
the at least one battery separator is configured to inhibit ionic transport between the first and second electrodes of the battery responsive to a temperature of the at least one battery separator exceeding a threshold temperature.
